(19) United States
(12) Patent Application Publication
(10) Pub. No.: US 2017/0239864 A9
(43) Pub. Date: Aug. 24, 2017

(54) MOLDING TOOLS WITH INTERCHANGEABLE INSERTS TO FORM A VARIETY OF PARTS WITH DIFFERING GEOMETRIES FROM A SINGLE TOOL

(71) Applicant: Joseph R. Cook, Parkland, FL (US)

(72) Inventor: Joseph R. Cook, Parkland, FL (US)

(21) Appl. No.: 14/057,833

(22) Filed: Oct. 18, 2013

Related U.S. Application Data
(63) Continuation-in-part of application No. 13/453,779, filed on Apr. 23, 2012.
Application No. 13/453,779 is a continuation-in-part of application No. 13/351,842, filed on Jan. 17, 2012, now Pat. No. 8,789,217.
Application No. 13/351,842 is a continuation of application No. 12/463,803, filed on May 11, 2009, now Pat. No. 8,112,831.
Application No. 12/463,803 is a continuation-in-part of application No. 11/724,913, filed on Mar. 17, 2007, now Pat. No. 8,141,182.
Application No. 11/724,913 is a continuation-in-part of application No. 13/402,704, filed on Feb. 22, 2012, now Pat. No. 9,167,940.
Application No. 13/402,704 is a continuation of application No. 11/724,913, filed on Mar. 17, 2007, now Pat. No. 8,141,182.

(51) Int. Cl. B29C 45/26; B29C 67/24

(52) U.S. Cl. CPC B29C 45/2673; B29C 67/246

(57) ABSTRACT

A first aspect of the invention relates to the manufacture of disparate workpieces by the process of injection molding using a single base tool. The tool is made up of cavity and core halves, and each half is made up of separate, removable/interchangeable, inserts which, when combined in a particular order, form the workpiece-forming surface. All or any number of the inserts may be replaced with other inserts to alter the workpiece-forming surface and allow a large number of differently shaped workpieces (i.e. having different surface features and shapes) to be formed from a single base tool. In another aspect of the invention, the inserts are connected to respective thermally conductive cavity and core mounting plates, which are in turn connected to respective cavity and core heating/cooling plates so that insert-mounting holes need not be made in the heating/cooling plates.

### CROSS-REFERENCE TO RELATED APPLICATIONS

This application is a continuation-in-part of co-pending application Ser. No. 13/453,779 filed Apr. 23, 2012. This application is also a continuation-in-part of co-pending U.S. application Ser. No. 13/351,842 filed on Jan. 17, 2012, which is a continuation of U.S. application Ser. No. 12/463,803 filed on May 11, 2009, now U.S. Pat. No. 8,112,831, which is a continuation-in-part of U.S. application Ser. No. 11/724,913 filed Mar. 17, 2007, now U.S. Pat. No. 8,141,182. This application is also a continuation-in-part of co-pending U.S. application Ser. No. 13/402,704 filed on Feb. 22, 2012, which was a continuation of U.S. application Ser. No. 11/724,913 filed on Mar. 17, 2007, now U.S. Pat. No. 8,141,182, which was commonly filed with the following U.S. patent application Ser. No. 11/724,873 now abandoned; U.S. patent application Ser. No. 11/724,914 filed Mar. 17, 2007, now U.S. Pat. No. 8,141,183; U.S. patent application Ser. No. 11/725,113 filed Mar. 17, 2007, now U.S. Pat. No. 8,209,795; U.S. patent application Ser. No. 11/724,912 filed Mar. 17, 2007, now U.S. Pat. No. 8,181,286; and U.S. patent application Ser. No. 11/725,112 filed Mar. 17, 2007, now U.S. Pat. No. 8,375,480.

### BACKGROUND OF THE INVENTION

1. Field of the Invention

This invention relates generally to the field of molding of workpieces, and, more specifically, relates to tools for manufacturing workpieces through injection molding, methods of use of such tools, and articles manufactured therefrom.

2. Description of the Prior Art

It is desirable in the field of injection molding to produce workpieces in the most efficient and cost effective manner possible. In general, workpieces, such as consumer products, are formed by closing two molding tool segments together to define one or more mold cavities therebetween, and injecting molten flowable material into the cavity under pressure. This cycle is repeated to produce numerous, identical products. Products are formed in this manner by, for example reaction, injection molding, resin transfer molding (RTM), low pressure molding, SMC and RIM-SCRIM tools.

One of the most widely used methods to produce certain products, such as automobile bumpers and prefabricated shower and bathroom pans, is known as reaction injection molding (RIM). In RIM, first, the two parts of a polymer are mixed together. The mixture is then injected into the mold cavity under high pressure using an impinging mixer. The mixture is allowed to sit in the mold long enough for it to expand and cure.

The most common RIM processable material is polyurethane, but others include polyureas, polyisocyanurates, polyesters, polyphenols, polyepoxides, and nylon 6. For polyurethane, one component of the mixture is usually polyisocyanate and the other component is usually a blend of polyol, surfactant, catalyst and blowing agent.

The tooling components are typically made from machined steel or aluminum, cast aluminum, silicone rubber and/or epoxy resin, and can be large or small depending on the size of product required.

In most injection molding operations, the molding tool is broken up into a core half and a cavity half. Each of the core half and cavity half have workpiece-forming surfaces that define the respective upper and lower surfaces of the workpiece to be formed. The workpiece-forming surface of the core half of the tool is defined by a single piece of tool material such as metal, and likewise for the workpiece-forming surface of the cavity half of the tool. Such surfaces are required to be precise to within very narrow tolerances. Therefore, great expense is incurred in the preparation of such tools.

The tooling components can be large or small depending on the size of product or part to be produced, and the number of discreet molding cavities in the tool. Once a product or part is designed, core and cavity tool components are precision-machined to form workpiece-forming surfaces which form the features of the desired product.

An undesirable by-product of such tooling arrangements is that the tools may be used to manufacture workpieces of only one shape. Therefore, even though it is desired to change less than all of the features of a part, an entire new tool has to be made. Attempts have been made in the past to permit the variation of certain aspects of workpieces by the insertion of one or more plugs in either the cavity and/or core halves of the tool, for example to impress indicia on the workpiece. However, no completely modularized tooling system has ever been proposed.

An example of a plug arrangement is disclosed in U.S. Pat. No. 4,384,702 to Boskovic. Another is disclosed in U.S. Pat. No. 5,387,096 to Weiser. A still further example, involving removable mold components, is taught by U.S. Pat. No. 6,572,355, although the apparatus and method of use thereof employs a two-step molding process and is, therefore, not particularly relevant to the instant invention.

Other examples of molding tools with interchangeable parts are shown in U.S. Pat. No. 7,520,741 to Wilson, and U.S. Pat. No. 6,695,607 to Chiu. Both of the latter referenced patents, however, teach the use of removable sections from the fixed cavity and/or core pieces, as opposed to the use of a series of separate components which, when combined in the correct order, are used to mold workpieces of a particular configuration.

Therefore, it would be desirable to have a tool which can be used to mold a substantial number of differently configured work-pieces from a single base tool using a plurality of modular insert components which, when combined in the correct order, create a workpiece of a desired particular shape and surface contour.

In addition, in the practice of injection molding, it is commonplace, and usually necessary, to provide both a heating and a cooling medium for heating and/or cooling of the respective cavity and core halves of the tool. First, prior to and during injection of the polymer resin into the cavity formed between the cavity and core halves of the tool, heat is typically applied to the tool through channels formed in the cavity and core halves of the tool to maintain the resin at a predetermined temperature, which will facilitate flow of the resin uniformly throughout the cavity. After the cavity is filled with resin, it is necessary to cool the workpiece so that the resin hardens. This is accomplished by running a cooling medium through the same or other channels in the tool. For purposes of this discussion, the structural components of the tool through which heating and cooling channels are formed will be called “heating plates”.

Typically, the cavity and core heating plates are attached to the respective cavity and core platens of the tool in ways which are known to those of skill in the art. In turn, the product surface-forming tool halves that are to be used to create workpiece-forming surfaces are then attached to the respective cavity and core heating plates of the tool. Attaching the tooling components to the cavity and core heating plates requires drilling holes or bores in the heating plates. The space which such bores occupy competes with the space within the heating plates in which heat transfer channels reside, and if the bores are improperly located, they can puncture the heat transfer channels causing costly repairs to the tool. Furthermore, as additional bores are added, the tool begins to weaken, which eventually will undermine the stability and integrity of the tool. As a result, the number of bores which can be created in the heating plates is greatly limited, resulting in a concomitant limitation in the number and positioning of alternative tooling component inserts that can be used. This, in turn, limits the number of differently shaped workpieces that can be formed from a given tooling set. Therefore, it is desirable to devise an apparatus which will minimize, or entirely eliminate, the need to create bores in the heating plates to accommodate tooling component fasteners.

To alleviate this problem, it would be desirable to provide a structural arrangement whereby tooling components can be indirectly affixed to the heating plates in essentially any position relative thereto without the necessity of creating bores in the heating plates themselves.

One type of workpiece which can manufactured from molding tools and their use is the prefabricated shower pan, as well as individualized prefabricated components thereof which can be assembled in the field to create a prefabricated waterproof shower pan. Prefabricated waterproof shower pans have become the most effective solution for the construction of tileable shower and bath enclosures, as they provide a one-piece waterproof surface over which flooring and/or wall finishing material (such as tile) can be installed. Such pans are in wide use today.

Prefabricated waterproof shower pans, as well as the floor portion of partially prefabricated shower pans, must have drains, or drain apertures, positioned therein to coincide substantially with the location of the floor (wastewater) drain in the subfloor. It has heretofore been necessary to create an entirely different set of cavity and core tool components when either or both of the size of a shower pan or the location of the drain or other shower pans components were changed. Given this fact, it has heretofore been cost prohibitive to have available a complete product line to satisfy the demand for waterproof shower pans with the wide variety of sizes and different drain locations, curbs, entrances, and other features required by the customer.

It would be desirable, therefore, to provide a single base tool from which can be manufactured a wide variety of workpieces (e.g. shower pans of different sizes, shapes and pitch having different drain locations as well as drain types (e.g. circular, linear, cast iron, PVC, ABS, standard, etc)), having a variety of entrances with one or more curbs, barrier free entrances, entrances with partial curbs and partial barrier free entrances, entrances with partial splash walls and partial curbed or barrier free entrances and curbs of various lengths, heights and widths, and having different splash wall with different lengths, heights and widths.

It is, therefore, a principal object of this invention to provide a single base tool from which can be manufactured a wide variety of workpieces. It is also an object of this invention to eliminate the problems associated with affixing tooling components directly to the cavity and core heating sections of an injection molding tool.

It is a further object of this invention to provide prefabricated waterproof shower pans and partially prefabricated shower pans made up of prefabricated waterproof components thereof, from a single base tool but with the ability to have any number of structural features formed therein and to dimension the prefabricated pans and partially prefabricated pan components in virtually any way.

### SUMMARY OF THE INVENTION

A first aspect of the invention relates to the manufacture of disparate workpieces by the process of injection molding using a single base tool. In one embodiment, the tool is made up of cavity and core halves, and each half has associated therewith a tool insert mounting plate on which are respectively mounted inserts which collectively define cavity and core workpiece-forming surfaces. Each tool half has associated therewith a collection of separate inserts or tooling components which, when combined in a particular order, form the workpiece-forming surfaces. Any number of the inserts may be replaced with other inserts in the tool to alter the workpiece-forming surface and allow a workpiece with different surface features and shape to be formed from the very same base tool.

Some products which a manufacturer may want to vary the features (e.g. proportions, features, partial shapes, etc.) of, while still making all variations thereof from a single base tool, may nevertheless have some features that will remain constant across more than one, if not all, of the products. The surfaces of such products, and hence of the tool surfaces which make those products, may be viewed as being dividable into areas, each of which area has one or more features that will be common, at least to some extent, across all of the workpieces to be made from that particular tool (“feature-consistent areas”) such as drains, curbs, pitched (i.e. sloped) planar areas, barrier free entrances, splash walls, trenches, which may have different sizes and shapes. To simplify the assembly and disassembly process of such a tool, the various feature-consistent areas of the cavity and core halves of the tool can be viewed as “zones”. The tooling components for each zone of the tool are selected from a universe of potential components for each zone. Selection of different sets of components from the universe of potential components for any given zone results in a differently shaped workpiece, or at least permits the alteration of all or a portion of the zones and, hence, permits the workpiece, to be partially or completely varied without creating a partial or entirely new tool. A planar area/section of the surface of a shower pan floor is an example of such a zone. It is, in certain circumstances, desirable to create shower pan floors which have as much of the surface area thereof planar, or flat, so that is it easy to secure tile thereto. Floors having valleys therein require additional cutting of flooring material (e.g. ceramic tile) to follow the contours of the topography, making it more labor intensive to install a shower. The use of entire rows and columns of constant pitch inserts allows for the use (and, hence, fabrication) of the bare minimum number of such inserts to make any pan or prefabricated pan from a single tool.

By providing a universe, or collection, of inserts for each zone of the cavity and core sections of a molding tool, one can manufacture any size part, in any shape, while varying individual features relative to other features of the part. For example, in the manufacture of waterproof shower pans, one can make numerous differently sized and/or shaped pans in a given tool, with any type of drain (e.g. PVC, cast iron, linear, standard) and any curb, sidewall and threshold features. The type, number and location of the drain(s) can be varied from part to part, as can the pitch of the floor (e.g. the floor can be a single planar section, can include a V-shape when viewed in elevation, or any combination thereof).

It can be appreciated that, in the case of workpieces such as shower and bath components over which water is designed to flow with minimal obstruction and to be easily tiled, the transitions between zones should be smooth. To accomplish this in the circumstances where smooth transitions are desired, the inserts which abut an adjacent zone or zones are configured and arranged such that there is a smooth transition between such zones which facilitates the shower pan to be easily and properly tiled. In other cases, the transition between adjacent zones may be abrupt, as in the case of a consumer product having an irregular shape.

In another aspect of the invention, the inserts and heating plates are connected to thermally conductive mounting plates which are positioned between the respective heating/cooling plates of the tool and the inserts so that holes which are used to connect the inserts to the tool do not reduce the internal volume of the heating/cooling plates or pierce the heating/cooling plates. If used in any given application, the heating/cooling plate(s) of the cavity half of the tool are mounted to one side of the mounting plate(s) for the cavity half of the tool and the cavity side workpiece inserts on the other side of the mounting plate(s), and the heating/cooling plate(s) of the core half of the tool are mounted to one side of the mounting plate(s) for the core half of the tool and the core side workpiece inserts on the other side of the mounting plate(s), thereby permitting a limitless number of points connection for the core and cavity workpiece inserts without in any way impacting the respective heating plates.

### BRIEF DESCRIPTION OF THE DRAWINGS

FIG. 1A is a schematic plan representation of a cavity half of a first molding tool divided into feature consistent areas.

FIG. 1B is a schematic plan representation of a core half of a first molding tool divided into feature consistent areas.

FIG. 1C is a schematic plan representation of a cavity half of a second molding tool divided into feature consistent areas.

FIG. 1D is a schematic plan representation of a core half of a second molding tool divided into constant feature zones feature consistent areas.

FIG. 1E is a schematic plan representation of a cavity half of a third molding tool divided into feature consistent areas.

FIG. 1F is a schematic plan representation of a core half of a third molding tool divided into feature consistent areas.

FIG. 1G is a schematic plan representation of a cavity half of a fourth molding tool divided into feature consistent areas.

FIG. 1H is a schematic plan representation of a core half of a fourth molding tool divided into feature consistent areas.

FIG. 2 is an exploded elevational view of an injection molding tool in accordance with one aspect of the invention.

FIG. 3 is a perspective view of an example of a mounting plate which can be used in accordance with the invention.

FIG. 4 is a perspective view of a partially assembled cavity half of a tool in accordance with one aspect of the invention.

FIG. 5 is a perspective view of a partially assembled core half of a tool in accordance with one aspect of the invention.

FIG. 6 is a perspective view of a fully assembled cavity half of a tool used to mold a shower pan with a circular drain.

FIG. 7 is a perspective view of a fully assembled core half of a tool used to mold a shower pan with a circular drain.

FIG. 8A is a top plan view of a plurality of cavity drain insert locator plates housed in a storage receptacle.

FIG. 8B is a top plan view of a plurality of core drain insert locator plates housed in a storage receptacle.

FIG. 9 is a perspective view of a fully assembled cavity half of a tool used to mold a shower pan with a linear trench having a standard drain attached to the trench.

FIG. 10 is a perspective view of a fully assembled core half of a tool used to mold a shower pan having a linear trench with a standard drain attached to the trench.

### DETAILED DESCRIPTION OF EXEMPLARY EMBODIMENT(S)

The inventive embodiments of my invention reside primarily in combinations of structural components and manufacturing, installation and use steps related to the creation of a variety of disparate molded workpieces, such as products made from injection molding processes, which can all be made from a single base tool using a series of strategically positioned, interchangeable inserts.

Accordingly, the apparatus components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms, such as “first” and “second,” “top” and “bottom,” and the like, may be used solely to distinguish one entity or element from another entity or element without necessarily requiring or implying any physical or logical relationship or order between such entities or elements.

The terms “comprises,” “comprising,” “comprise” or any other variation thereof are intended to cover a non-exclusive inclusion, such that a process, method, article, or apparatus that comprises a list of elements need not necessarily include only those elements, but may include other elements not expressly listed or inherent to such process, method, article, or apparatus.

The term “plurality of” as used in connection with any object or action means two or more of such objects or actions.

A claim element proceeded by the article “a” or “an” does not, without more constraints, preclude the existence of additional identical elements in the process, method, article, or apparatus that includes the element.

The term “molding tool” encompasses any apparatus used to create a product from flowable, hardenable material which is injected under pressure into one or more cavities defined by the tool.

Terms such as “wall or flooring material,” “floor and wall covering,” “flooring material” and “covering material” mean, encompass and comprise one or more of ceramic, natural stone or other tile, stone, granite, marble, cultured marble or any other surface (e.g. stone), or non-slip finished shower surfaces such as vinyl or plastic, stucco, concrete and mortar surfaces, whether or not applied or combined with adhesives or other substances, and any other material or materials used to provide a finished surface.

The term “tiled” means, encompasses and comprises any surface having floor or wall covering materials, such as one or more of ceramic, natural stone or other tile, stone, granite, marble, cultured marble or any other surface (e.g. stone), or non-slip finished shower surfaces such as vinyl or plastic, stucco, concrete and mortar surfaces, whether or not applied or combined with adhesives or other substances, and any other material or materials used to provide a finished surface.

The term “non tileable” means, encompasses and comprises one or more surfaces or structural components which are not capable of receiving wall or floor material or were not designed, marketed or sold with the intention of being tileable or tiled, and in fact are not tiled.

The term “tileable” or “ready-to-tile” means, encompasses, and comprises one or more surfaces or structural components which are capable of receiving wall or flooring material, whether through the use of adhesives or any other means of attachment, such as clips, straps or other mechanical fastening structure(s).

The term “prefabricated shower pan” means, encompasses and comprises any manufactured or fabricated one piece shower pan (A) to which floor or wall coverings may be adhered, (B) which at the time of manufacture has either (i) a trench integrally associated therein or (ii) a molded or prefabricated trench integrally formed with one or more standard drain bodies, both of which are integrally associated into the shower pan at the time of manufacture or fabrication of such shower pan, or (iii) a drain integrated into the floor of the shower pan but such drain is not part of a trench drain nor is it located within a trench, and (C) which may also have integrated therein at the time of manufacture or fabrication a floor (which may be pitched), one or more splash walls, one or more curbs, and/or one or more barriered or barrier-free entrances.

The term “partially prefabricated shower pan” means, encompasses and comprises any manufactured or fabricated shower pan assembly or kit to which floor or wall coverings are to be adhered which is not a one piece shower pan, but has two or more pieces which are assembled at any time after manufacture and prefabrication, usually in the field at or around the time of assembly and installation of the shower pan, which when assembled and installed in the field comprises a one piece or multi-piece shower floor and which (A) does not have either (i) a molded or prefabricated trench together with a standard drain integrally formed into such shower pan at the time of manufacture or (ii) a trench drain integrally formed into such shower pan at the time of manufacture, or (iii) a standard drain integrally formed into such shower pan, but which may have (B) one or more manufactured or fabricated integrated components, or component elements which make up, features such as a floor, a splash wall, a curb and/or a barriered or barrier-free entrance, and (C) as individual components one or more of a trench drain body, a standard drain body, a trench body, an integrally formed trench body and a standard drain, a trench body integrally formed with all or a portion of a shower pan floor, and a trench body and a standard drain integrally formed with all or a portion of a shower pan floor, and a standard drain integrated into (e.g. integrally formed with) all or a portion of a shower pan floor where there is no trench.

Terms such as “tiled and/or tileable surface or fixture” and “surface or fixture” mean, encompass, and comprise any fully or partially tiled and/or tileable bathtub, bathroom floor, shower floor, sink, fountain, fixture, floor, or other surface.

The term “non tileable and/or untiled surface” means, encompasses and comprises a surface such as a floor, wall, shower floor, bath floor, sink, shower pan, or any other surface which has a drain integrated or associated with it, and such surface is either not tileable, or is not designed to be tiled or tileable, and/or such surface is in fact not tiled.

The term “standard drain” means, encompasses and comprises any kind of drain made of any kind of material, including but not limited to metal or plastics, and with any kind of connection to a drain system such as a waste water system, including but not limited to a solvent weld drain, a welded connection drain, a hub (outside caulk) drain, a spigot drain, a hubless spigot drain, a hubless drain, an inside caulk (gasket) drain, a hubbed (push on) drain, a compression drain, and a clamping ring drain, but does not include a trench drain.

The term “drain area” means an area in which a drain is either to be formed or installed, or is actually formed or installed, in a shower pan.

The term “drain floor” means an area in which a drain recess is created and in which a drain fixture is installed or to be installed, formed or to be formed, or otherwise created, regardless of when it is installed, formed or otherwise created.

The term “trench drain” means, encompasses and comprises existing integrally formed trench drains (also known as “linear drains”) such as those which meet the requirements of the various plumbing codes pertaining to a trench drain.

The term “trench body” or “trench” means, encompasses and comprises molded trench bodies or preformed or prefabricated trench bodies and other voids into which liquids may otherwise drain, such as depressions in a shower, bath, sink, basin or bathroom floor, whether preformed or formed during the assembly of the shower pan, bath tub, sink, basin or floor which may or may not be leak proof at the time the trench body is preformed, prefabricated, or molded, or subsequently made water proof sometime after manufacture such as in the field at or about the time of installation of the shower pan, and which is made from any appropriate material including but not limited to metal, such as cast iron, copper, steel, aluminum, plastics such as PVC or ABS, polyurethane, polyethylene, polymer resins, or the like.

The term “pre-manufactured” means, encompasses and comprises any component of a shower pan that is manufactured prior to incorporation of that component into another product.

The term “molded’ means, encompasses and comprises any component that is formed with a finished product at the time that the finished product is molded.

The term “grate free” means any area over, near or in registry with a drain into which water or other liquid may drain which is substantially free of obstruction.

The terms “pitch” or “slope” mean the change in elevation per unit of length of floor. A typical shower pan floor pitch is ¼″ per foot, although any pitch is deemed to be within the scope of the inventions disclosed herein.

The term “workpiece” means any product and/or part created through a manufacturing process using thermoplastic or thermosetting plastic materials.

The terms “surface-forming inserts,” “workpiece surface-forming insert,” “workpiece surface-defining block,” “workpiece surface-forming block” and “surface-forming block” mean modular tool components which define molding surfaces which, when combined with other compatible modular tool components, collectively form a workpiece-forming surface when attached to a tool.

The terms “block”, “insert”, and “insert block” refer to removable injection molding tooling components, some of which are used to form workpiece-forming surfaces and some which do not form workpiece surfaces, such as injector and gate components, as well as tool guiding components, employed in the injection molding tool.

The term “modular zone” means a zone or area of a tool made up of two or more insert blocks attached to the heating/cooling plates of the cavity or core of a tool, or attached to a mounting plate which in turn is adapted to be connected to a heating/cooling plate of the cavity or core of a tool, which are used to create an area of a workpiece.

The term “modular zone-specific inserts” refers to the collection of inserts that are intended to be used to create any configuration of a specific zone, where the workpiece surface contour for the particular zone is intended to be varied from one workpiece to another.

The terms “multi-pitched workpiece surface” and “multi-pitched surface” refer to tool and corresponding workpiece surfaces that have pitch or slope in more than one plane.

The inventions disclosed herein may be employed in, by example but not by way of limitation, sinks, basins, showers, baths, shower pans, fixtures, and any other surface or fixture from which liquid is to be drained.

The basic components of an inventive modular injection molding tool or apparatus in accordance with the invention include one or more first and second heating/cooling plates, corresponding to the cavity and core, optional one or more first and second thermally conductive mounting plates, corresponding again to the cavity and core sides of the tool, and sets or collections of modular core and cavity side workpiece surface-forming inserts from which can be selected groupings of inserts which are adapted to be mounted to the one or more cavity and core portions of the tool, respectively, to form a volume or cavity into which is injected a flowable, hardenable material (e.g. polymer resin) to form a workpiece. To modify the configuration of the workpiece, some or all of the inserts are removed and replaced by other inserts from the afore-mentioned collections of inserts, and the injection molding process repeated. In this way, any number of differently shaped workpieces can be molded from a single base tool by merely changing out some or all of the inserts used to make up the volume or cavity and replace the removed inserts with other inserts.

The base tool, therefore, in the preferred embodiment is comprised of one or more standard cavity and core heating/cooling plates, to which are connected one or more cavity and core workpiece surface-forming inserts. Alternatively, as will be discussed hereinafter, the base tool may be comprised of one or more cavity and core mounting plates connected respectively to the one or more cavity and core heating/cooling plates, and the cavity and core workpiece surface-forming inserts in turn connected respectively to the one or more cavity and core mounting plates.

The inserts may be broken down and/or segregated in any manner. For simplicity, each of the cavity and core sections of the tool may be broken down into areas, zones or sections, each area, zone or section corresponding to a different (e.g. independent) structural feature of the workpiece to be formed, so that varying the workpieces which are produced from one base tool arrangement can be accomplished by simply changing one or more of the workpiece surface-forming inserts in a single (or multiple) area, zone or section.

For example, in the case of a prefabricated shower pan, the principal structural features may include a pan floor, a drain, a curb (or curbless entry) and splash walls (also known as sidewalls). Cavity and core surface-forming inserts used to manufacture each structural feature of such a pan can be grouped together into generalized sets, collections or surface area groups of inserts, each set corresponding to one of the afore-mentioned areas, zones or sections of the tool. The various inserts within any given set (e.g. floor, drain, curb/entry, splash wall, etc.) are designed to be combined in a variety of ways to create a desired topology of the zone of the workpiece to which they relate. Therefore, it is efficient to group, label and/or store them together so that they can be easily selected from at the time a tool is assembled.

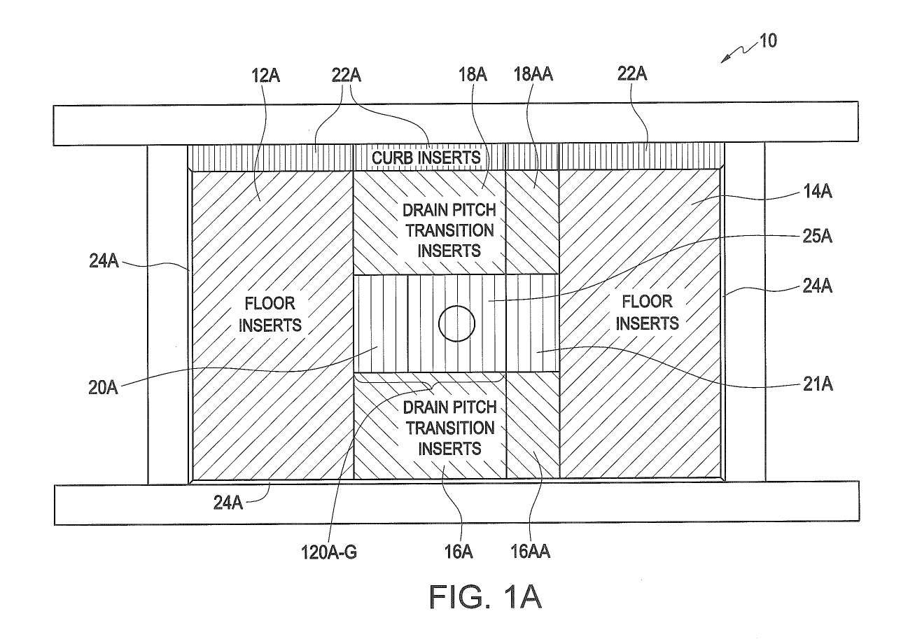

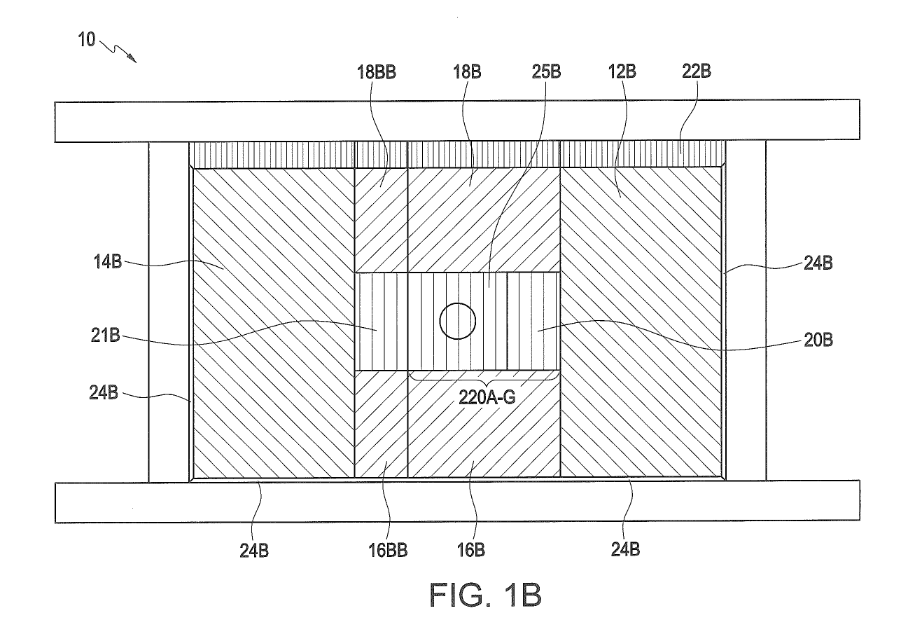

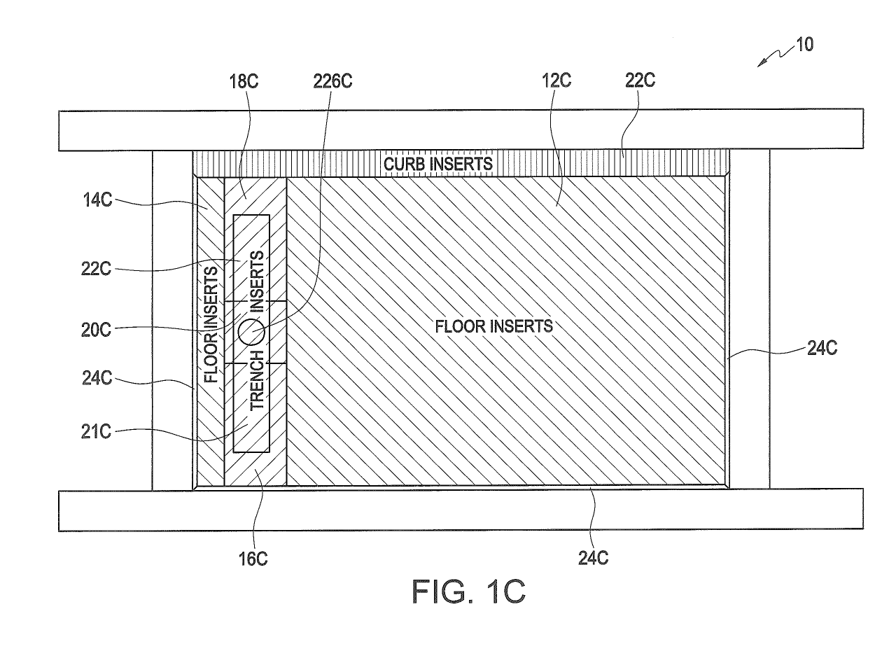

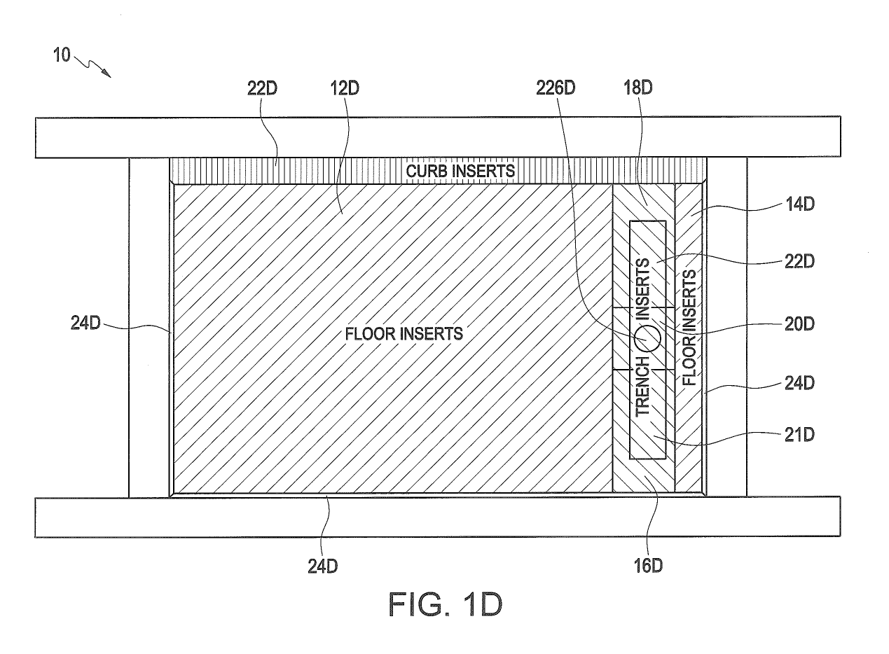

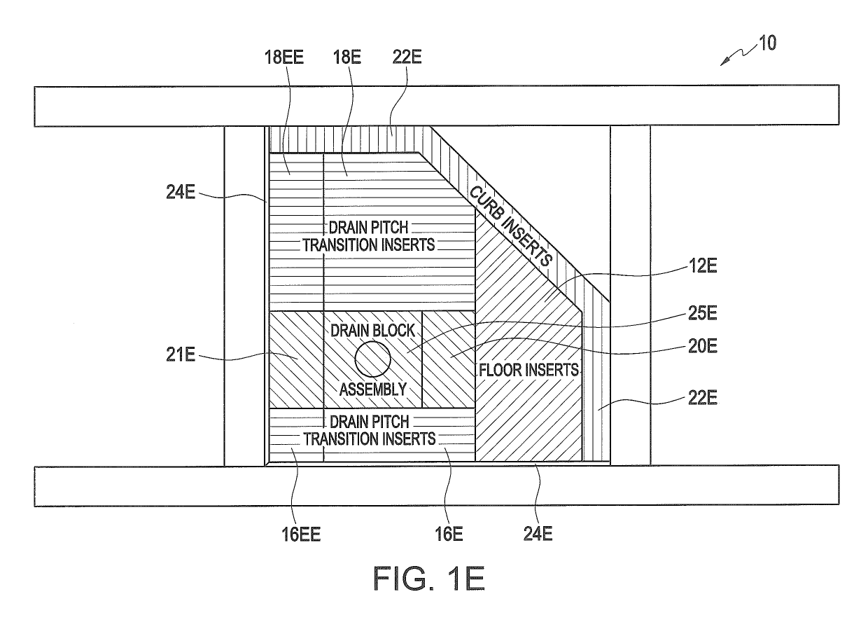

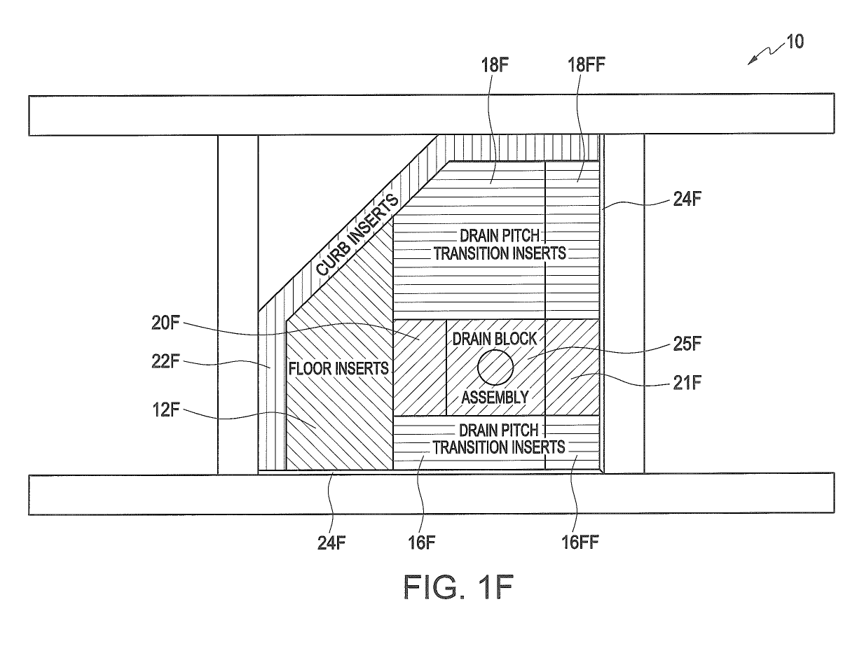

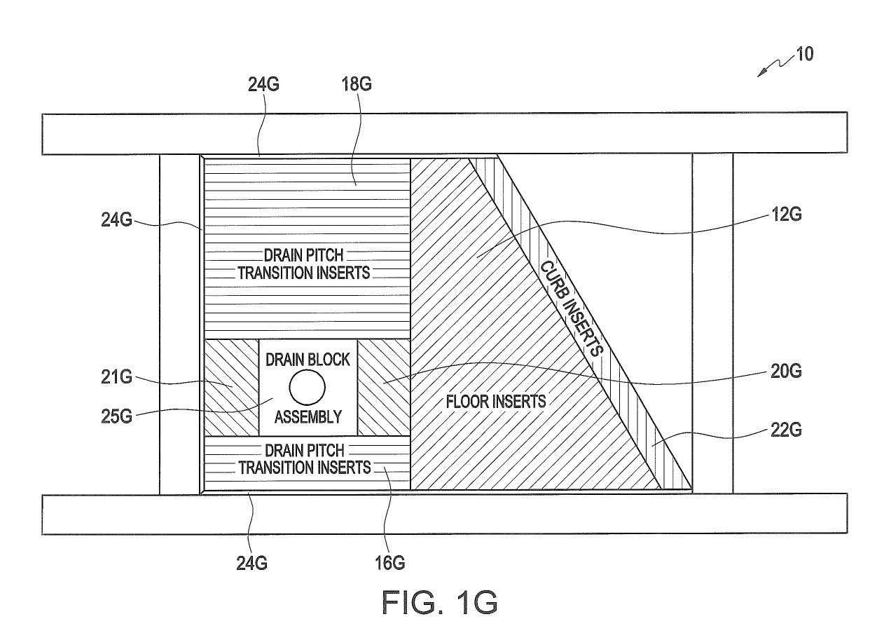

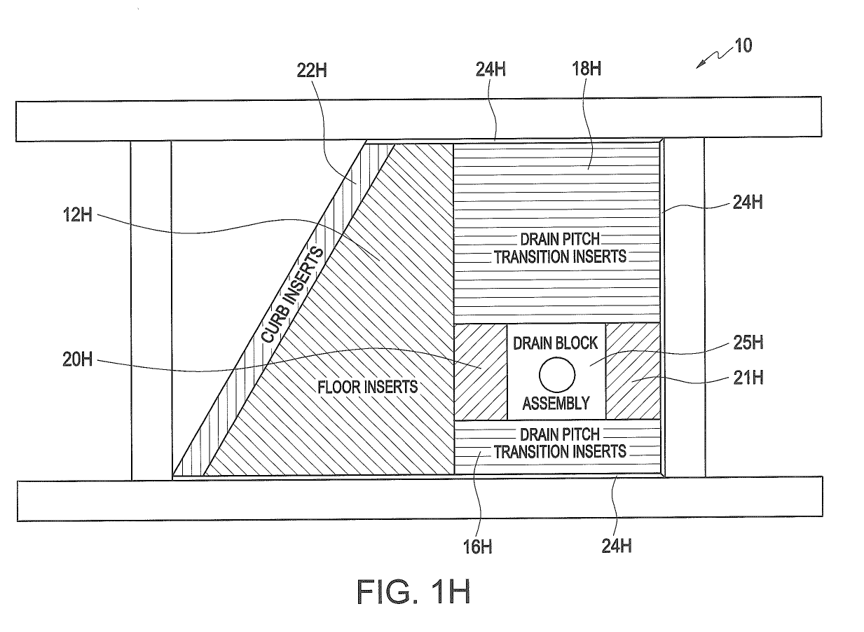

As but one example, shown in FIG. 1A, a schematic representation of a cavity half of a tool to manufacture a prefabricated waterproof shower pan in accordance with the principals of this invention is shown in which are portrayed features such as one or more constant-pitch (i.e., planar) floor insert areas 12A, 14A (which floor inserts create one or more planar floor area(s) in the pan), one or more drain pitch transition insert areas 16A, 18A (which drain pitch transition inserts create the necessary smooth water flow transition area(s) between planar floor area(s) and the drain area(s) or drain), one or more extension drain pitch transition inserts areas 16AA and 18AA, one or more drain insert areas 20A,21A, and 25A (which drain inserts create a drain area in the floor), one or more curb insert areas 22A (which curb inserts create one or more entry areas in the pan), and one or more splash wall insert areas 24A (which splash wall inserts create one or more splashwalls or sidewalls in the pan. The physical characteristics (i.e., topology and dimensions) of the various areas 12A, 14A, 16A, 16AA, 18AA, 20A, 21A, 25A, 22A,24A in the tool may differ in location, size and shape relative to any other area and relative to the overall tool area in accordance with the needs of a particular design. Also, additional and/or alternative feature consistent insert areas may be used to accommodate additional and/or alternative workpiece features. The core half of the tool will likewise be made up of corresponding areas.

To that end, FIG. 1B shows a schematic representation of a core half of a tool used to manufacture a prefabricated waterproof shower pan in accordance with the principals of this invention in which features such as one or more constant-pitch (i.e., planar) floor insert areas 12B, 14B, one or more drain pitch transition insert areas 16B, 18B, one or more drain pitch extension inserts 16BB, 18BB, one or more drain insert areas 20B, 21B, 25B, one or more curb insert areas 22B and one or more splash wall insert areas 24B, are portrayed. The physical characteristics (i.e., topology and dimensions) of the various areas 12B, 14B, 16B, 16BB,18B, 18BB, 20B, 21B, 25B, 22B and 24B in the tool may differ in location, size and shape relative to any other area and relative to the overall tool area in accordance with the needs of a particular design. Also, additional and/or alternative feature-consistent insert areas may be used to accommodate additional and/or alternative workpiece features.

It is to be understood that each zone may be its own modular zone made up of modular zone-specific inserts. For example, cavity and core floor insert areas 12A, 14A, 12B and 14B may each be comprised of a series of inserts which are attached to modular mounting plates, which inserts create the surface-forming contour of the cavity and core sides of the tool, respectively. In this example, floor zone 12A is comprised of two or more inserts that are mounted to a zone-specific mounting sub-plate for that zone. When it is desired to change the size, pitch or other feature of the floor of the pan, the mounting sub-plate can be removed with the inserts retained in place for further use of that sub-plate at a later time. After removal thereof, one or more replacement sub-mounting plates with other inserts mounted thereon can be brought in to create a modified tool. Alternatively, replacement inserts can be mounted to the tool in place of one or more replacement sub-mounting plates.

FIG. 1C is a schematic representation of a cavity half of a tool to manufacture a prefabricated waterproof shower pan having a linear trench with a standard drain, in which features such as the linear trench insert areas or zones 16C, 18C, 20C, 21C and 22C, the standard drain insert areas or zones 25C, one or more constant-pitch (i.e., planar) floor insert areas or zones 12C, 14C, one or more curb insert areas or zones 22C and one or more splash wall insert areas or zones 24C, are portrayed. The physical characteristics (i.e., topology and dimensions) of the various areas 12C, 14C, 16C, 18C, 20C, 21C, 22C, 25C and 24C in the tool may differ in location, size and shape relative to any other area and relative to the overall tool area in accordance with the needs of a particular design. Also, additional and/or alternative feature consistent insert areas may be used to accommodate additional and/or alternative workpiece features. The core half of the tool will likewise be made up of corresponding areas.

To that end, FIG. 1D shows a schematic representation of a core half of a tool used to manufacture a prefabricated waterproof shower pan having a linear trench with a standard drain, (the cavity half of which is shown in FIG. 1C) in accordance with the principals of this invention in which features such as one or more linear trench insert areas 16D, 18D, 20D, 21D and 22D areas or zones, the standard drain insert 25D areas or zones, constant-pitch (i.e., planar) floor insert areas 12D, 14D, one or more curb insert areas 22D and one or more splash wall insert areas 24D, are portrayed. The physical characteristics (i.e., topology and dimensions) of the various areas 12D, 14D, 16D, 18D, 20D, 21D, 22D, 25D, and 24D in the tool may differ in location, size and shape relative to any other area and relative to the overall tool area in accordance with the needs of a particular design. Also, additional and/or alternative feature-consistent insert areas may be used to accommodate additional and/or alternative workpiece features. FIG. 1E is a schematic representation of a cavity half of a tool to manufacture a prefabricated waterproof shower pan having a Neo-angle feature, in which features such as one or more constant-pitch (i.e., planar) floor insert areas 12E, one or more drain pitch transition insert areas or zones 16E, 16EE, 18E and 18EE, one or more drain insert areas or zones 20E and 25E, one or more drain extension inserts or areas 21E, one or more Neo angle curb insert areas or zones 22E, and one or more splash wall insert areas or zones 24E, are portrayed. The physical characteristics (i.e., topology and dimensions) of the various areas 12E, 16E, 16EE, 18E, 18EE, 20E, 21E, 22E,24E and 25E in the tool may differ in location, size and shape relative to any other area and relative to the overall tool area in accordance with the needs of a particular design. Also, additional and/or alternative feature consistent insert areas may be used to accommodate additional and/or alternative workpiece features. The core half of the tool will likewise be made up of corresponding areas.

To that end, FIG. 1F shows a schematic representation of a core half of a tool used to manufacture a prefabricated waterproof shower pan having a Neo-angled feature (the cavity half of which is shown in FIG. 1E) in accordance with the principals of this invention in which features such as one or more constant-pitch (i.e., planar) floor insert areas 12F, one or more drain pitch transition insert areas 16F, 16FF, 18F, 18FF, one or more drain insert areas 20F and 25F, one or more drain extension inserts or areas 21F, one or more Neo-angle curb or entry areas 22F and one or more splash wall insert areas 24F, are portrayed. The physical characteristics (i.e., topology and dimensions) of the various areas 12F, 16F, 16FF, 18F, 18FF, 20F, 25F 21F, 22F and 24F in the tool may differ in location, size and shape relative to any other area and relative to the overall tool area in accordance with the needs of a particular design. Also, additional and/or alternative feature-consistent insert areas may be used to accommodate additional and/or alternative workpiece features.

FIG. 1G is a schematic representation of a cavity half of a tool to manufacture a prefabricated waterproof shower pan having an angle feature, in which features such as one or more constant-pitch (i.e., planar) floor insert areas 12G, one or more drain pitch transition insert areas or zones 16G, 16GG, 18G, 18GG, one or more drain insert areas or zones 20G and 25G, one or more drain extension inserts or areas 21G, one or more angled curb insert areas or zones 22G, and one or more splash wall insert areas or zones 24, are portrayed. The physical characteristics (i.e., topology and dimensions) of the various areas 12G, 16G, 16GG, 18G, 18GG, 20G, 25G, 21G, 22G and 24G in the tool may differ in location, size and shape relative to any other area and relative to the overall tool area in accordance with the needs of a particular design. Also, additional and/or alternative feature consistent insert areas may be used to accommodate additional and/or alternative workpiece features. The core half of the tool will likewise be made up of corresponding areas.

To that end, FIG. 1H shows a schematic representation of a core half of a tool used to manufacture a prefabricated waterproof shower pan having an angled feature (the cavity half of which is shown in FIG. 1G) in accordance with the principals of this invention in which features such as one or more constant-pitch (i.e., planar) floor insert areas 12H, one or more drain pitch transition insert areas 16H, 16HH, 18H, 18HH, one or more drain insert areas 20H and 25H, one or more drain extension inserts or areas 21H, one or more curb insert areas 22H, one or more angled curb or entry areas and one or more splash wall insert areas 24H, are portrayed. The physical characteristics (i.e., topology and dimensions) of the various areas 12H, 16H,16HH, 18H, 18HH, 20H, 25H, 21HH, 22H and 24H in the tool may differ in location, size and shape relative to any other area and relative to the overall tool area in accordance with the needs of a particular design. Also, additional and/or alternative feature-consistent insert areas may be used to accommodate additional and/or alternative workpiece features.

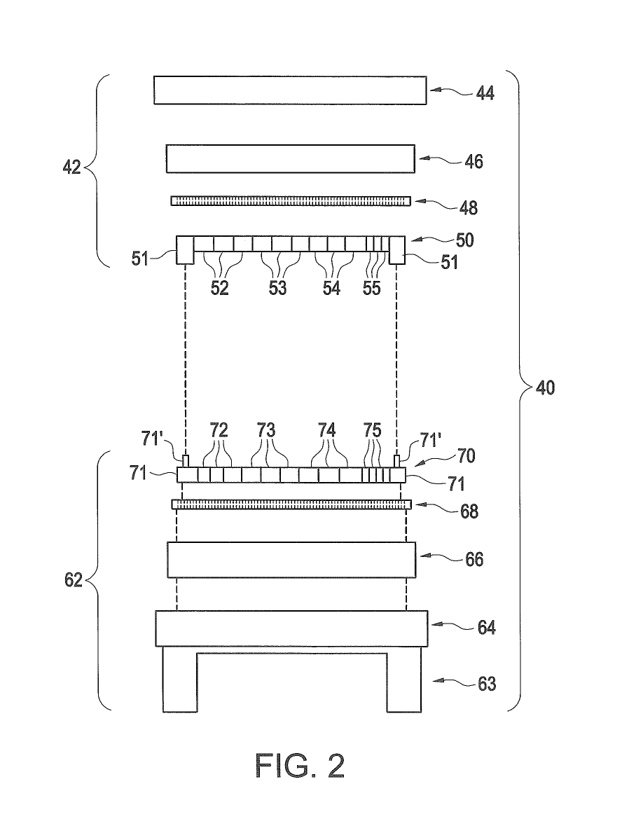

FIG. 2 is a schematic representation of a typical injection molding press 40, comprised of first, cavity, components 42 and second, core, components 62.

Cavity components 42 comprise a cavity platen 44, a cavity heating/cooling plate 46, an optional cavity mounting plate 48, and a series of cavity inserts 50, which will be described in detail below.

Core components 62 are comprised of a floor support or base 63 (optional), a core platen 64, core heating/cooling plate 66, an optional core mounting plate 68 and a series of core inserts 70. It is to be understood that the basic components of molding presses vary from one machine to the next, and the principals of this invention may be carried out with any of them. For example, the platen and heating/cooling plate may make up a single component of the tool.

The respective cavity and core heating/cooling plates and mounting plates may be referred to as “mounting members.”

In order to ensure that tool halves 42 and 62 mate accurately, cavity alignment guides 51, which may be in the form of removable, interchangeable, inserts, may be used. Guides 51, as used, are connected to cavity mounting plate 48, and define interior bores 51′ into which core alignment pins 71′ of core alignment inserts 71 nest when cavity and core tool halves 42, 62 are brought together. Apparatus such as guides 51 and alignment inserts 71 may be positioned in any location relative to the overall tool.

Cavity inserts 50 collectively define the workpiece-forming surface(s) which form one side of the resulting workpiece. Core inserts 70 define the workpiece-forming surface(s) which form the opposite surface of the resulting workpiece.

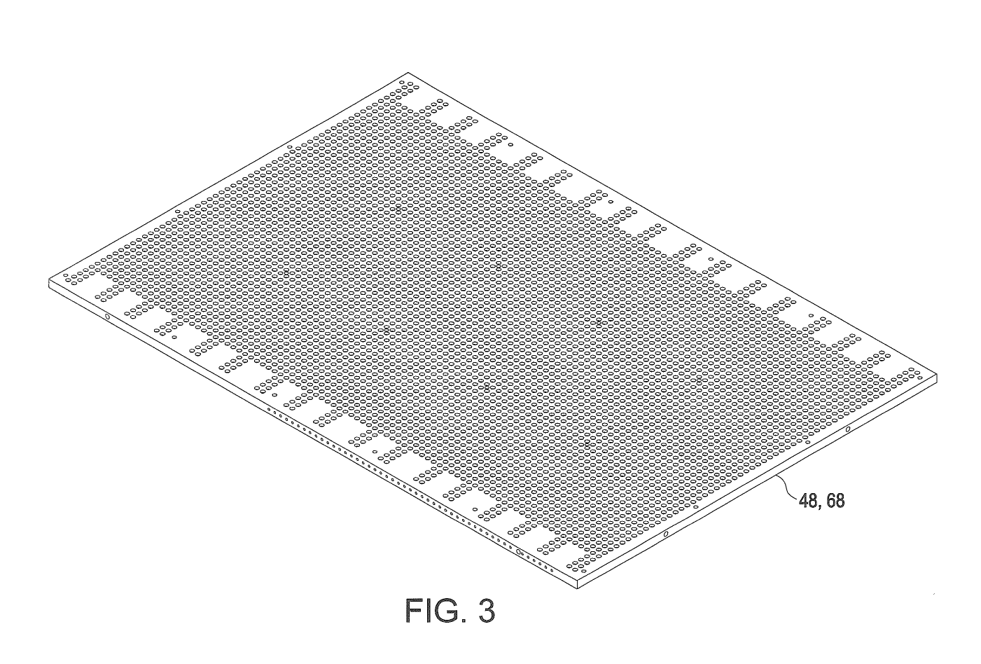

FIG. 3 is a perspective view of a representative thermally conductive mounting plate, such as mounting plates 48, 68 shown in FIG. 2. Each mounting plate 48, 68 defines a plurality of apertures therein, the majority of which are available to receive fasteners and/or locator pins (to be discussed hereinafter) to locate one or more inserts thereon. In addition, some of the apertures in plates 48, 68 may be used to mount plates 48, 68 to their respective heating/cooling plates 46, 66. The mounting plates 48, 68 are adapted to be connected to cavity and core heating/cooling plates 46, 66, respectively, in thermally conductive relation, so that heat may be effectively and efficiently transferred to/from heating/cooling plates 46, 66 through the mounting plates 48, 68 to the inserts. It is to be understood, however, that mounting plates need not be used, such that the cavity and core inserts 50, 70 (as well as other components such as guides 51 and guide inserts 71) will be connected directly (or indirectly as the case may be) to the heating/cooling plates 46, 66 or to other inserts. It should also be understood that while only one core mounting plate and one cavity mounting plates are depicted in the drawings, that one or more mounting plates may be used in any application of the principals of this invention.

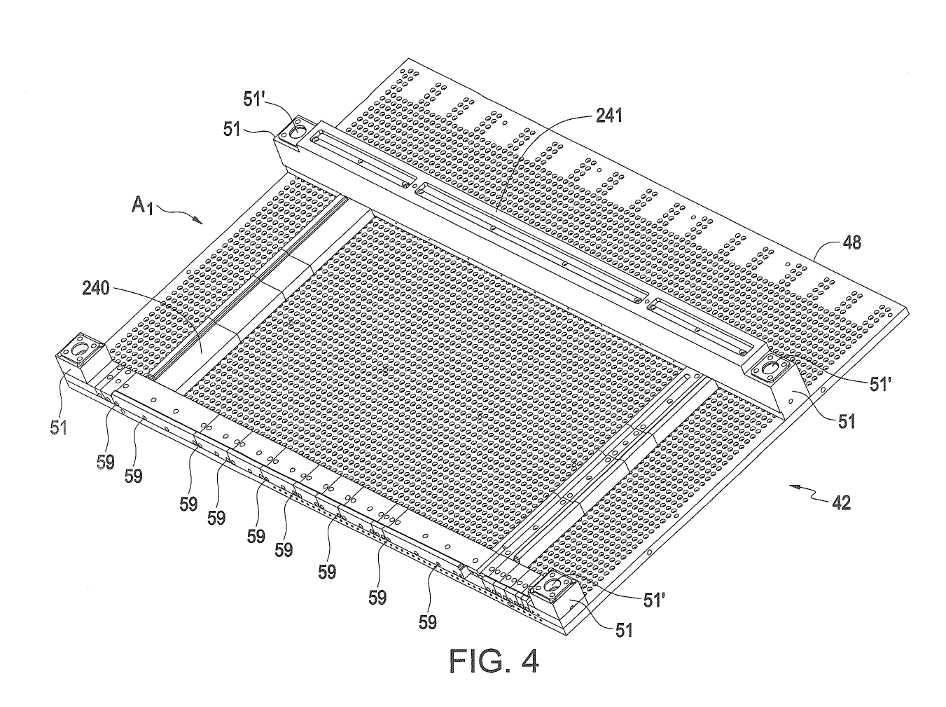

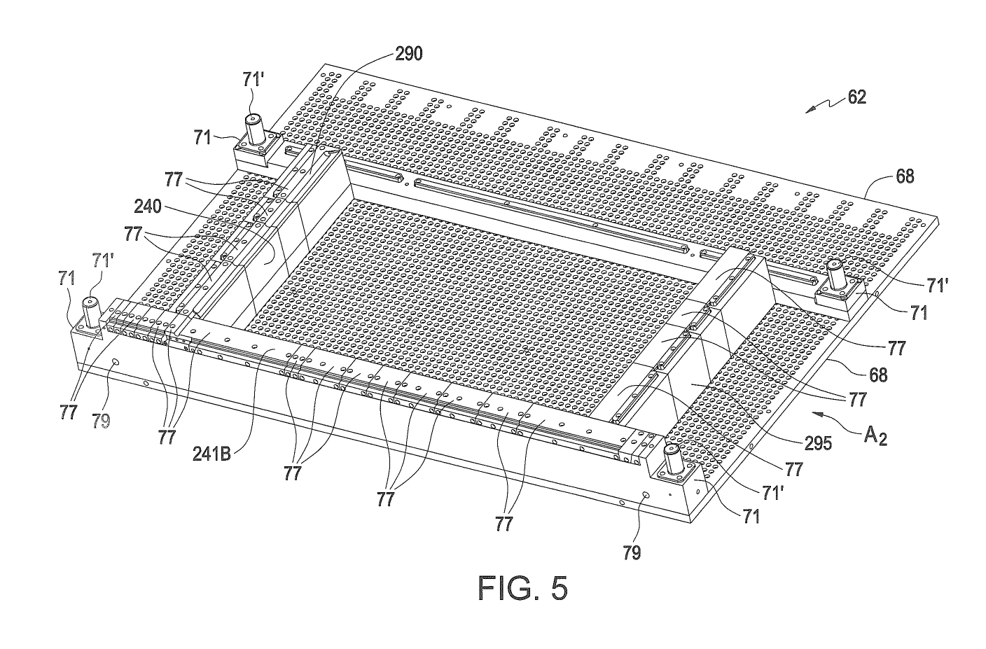

FIGS. 4-5 show mounting plates 48, 68 having connected thereto an initial number of representative cavity and core inserts 50, 70, respectively, including guide inserts and alignment pin inserts 51, 71, respectively, during the process of configuring a particular tool.

In the case of a prefabricated shower pan, cavity splash wall block(s) 59 (FIG. 4) and core splash wall block(s) 77 (FIG. 5) may be used and selected from a larger set of splash wall inserts which allow the splash walls to conform to the size of the shower pan. Inserts 59, 77 may be of any size and proportion. All that may be required is that each be sufficiently deep/tall/wide/long to create, when combined with additional inserts in the tool in a particular manner, the desired workpiece-forming surfaces. It can readily be seen by this arrangement that workpieces of any size or shape can be created from a single base tool by simply selecting the appropriate inserts from the various sets of inserts available to create the desired overall workpiece-forming surfaces.

The insert arrangements shown in FIGS. 4-5 are merely examples of the wide variety of tool arrangements contemplated by this invention. Once the remainder of the workpiece surface-forming inserts are attached to mounting plates 48, 68 (or directly to heating cooling plates 46, 66 in the absence of mounting plates 48, 68), and those mounting plates attached to their respective heating/cooling plates 46, 66, and the heating/cooling plates 46, 66 attached to their respective platens 44, 64 (not necessarily in any particular order), and tool halves 42, 62 are mated together such that end A₁ of tool cavity half 42 mates with end A₂ of tool core half 62, workpieces can be formed by injection molding.

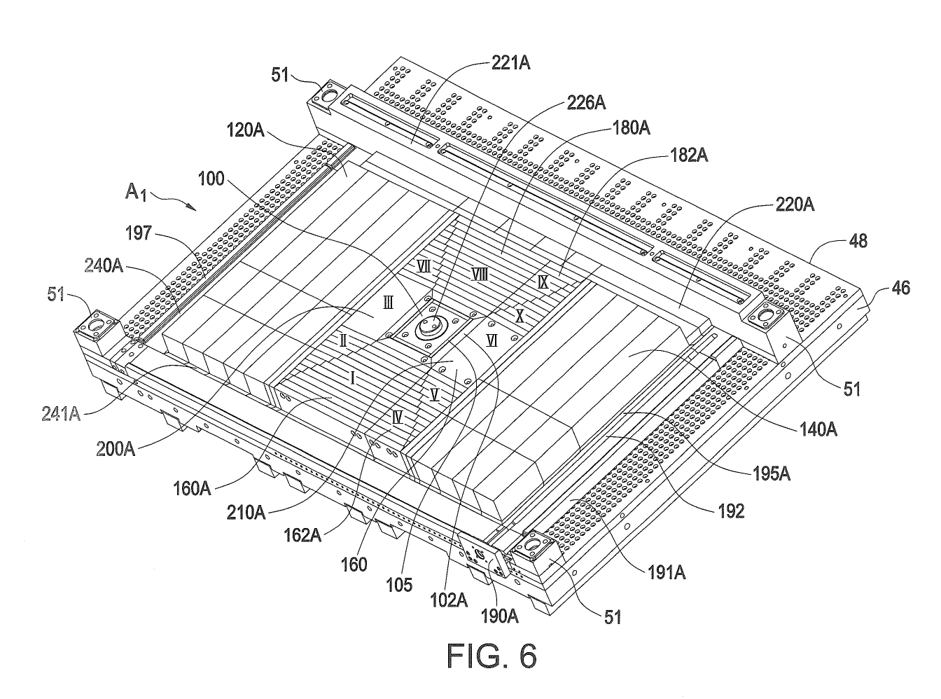

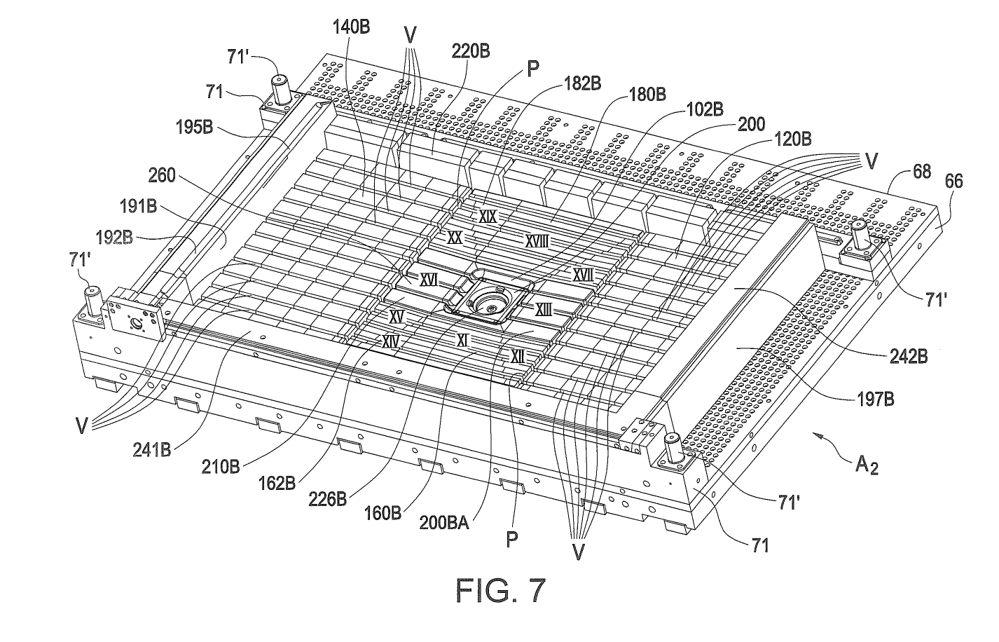

FIGS. 6-7 show examples of completed tooling arrangements with mounting plates, heating and cooling plates, and tool inserts required to manufacture a representative workpiece, in this case a pre-fabricated waterproof shower pan having a “center drain” of circular (as opposed to linear) configuration. FIG. 6 corresponds to the schematic representation of a cavity half of a tool shown in FIG. 1A, and FIG. 7 corresponds to the schematic representation of a core half of a tool shown in FIG. 1B. To create another workpiece that has some, but not all, of the same surface features as workpieces formed from the tool of FIGS. 6-7, some of the inserts are removed or relocated, and other inserts brought in, to change the overall surface-forming shape of the collective inserts.

The zones shown in FIG. 1A correspond to the sets of inserts shown in FIG. 6 as follows:

| Zone | Insert Set/Grouping |
|---|---|
| 12A | 120A |
| 14A | 140A |
| 16A, 16AA | 160A 162A |
| 18A, 18AA | 180A, 182A |
| 20A, 21A | 200A, 210A |
| 22A | 220A, 221A |
| 24A | 240A, 241A and 242A |
| 25A | 100 |

The zones shown in FIG. 1B correspond to the sets of inserts shown in FIG. 7 as follows:

| Zone | Insert Set/Grouping |
|---|---|
| 12B | 120B |
| 14B | 140B |
| 16B, 16BB | 160B 162B |
| 18B, 18BB | 180B, 182B |
| 20B, 21B | 200B, 210B |
| 22B | 220B, 221B |
| 24B | 240B, 241B and 242B |
| 25B | 200 |

All of the tooling components 50 and 70 for zones 12A, 14A, 16A, 16AA 18A, 18AA, 20A, 21A, 22A, 24A, 25A, 12B, 14B, 16B, 16BB, 18B, 18BB, 20B, 21B, 22B, 24B and 25B shown in FIGS. 1A and 1B are in place, attached to mounting plates 48, 68 of the cavity and core halves 42, 62 respectively, of the tool. In this version of the invention, the mounting plates s 48, 68 are connected to heating/cooling plates 46, 66, respectively.

As can be seen, drain locator plates 200A, 210A, 200B and 210B shown in FIGS. 6-7 will form a circular drain. In this example, it can be seen that a plurality of inserts 50, 70 are arranged in a pattern which creates workpiece-forming surfaces that, in turn, form a cavity (when placed in registry with one another) in which molding material such as polymer resin is injected to form a shower pan having a circular drain. To create another workpiece that has some, but not all, of the same surface features as workpieces formed from the tool of FIGS. 6-7, some of the inserts are removed or relocated, and other inserts brought in to change the overall surface-forming shape of the collective inserts.

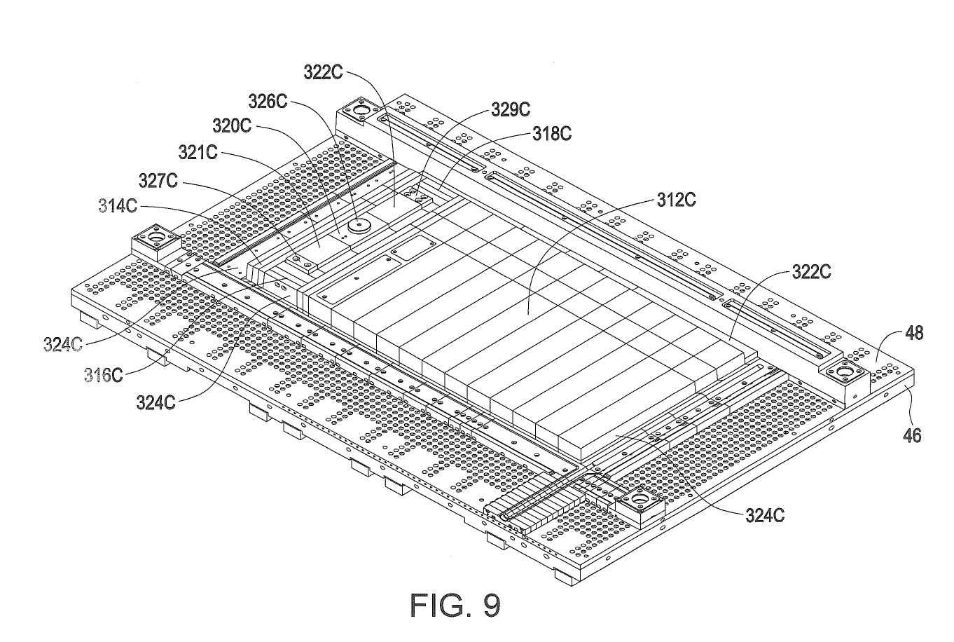

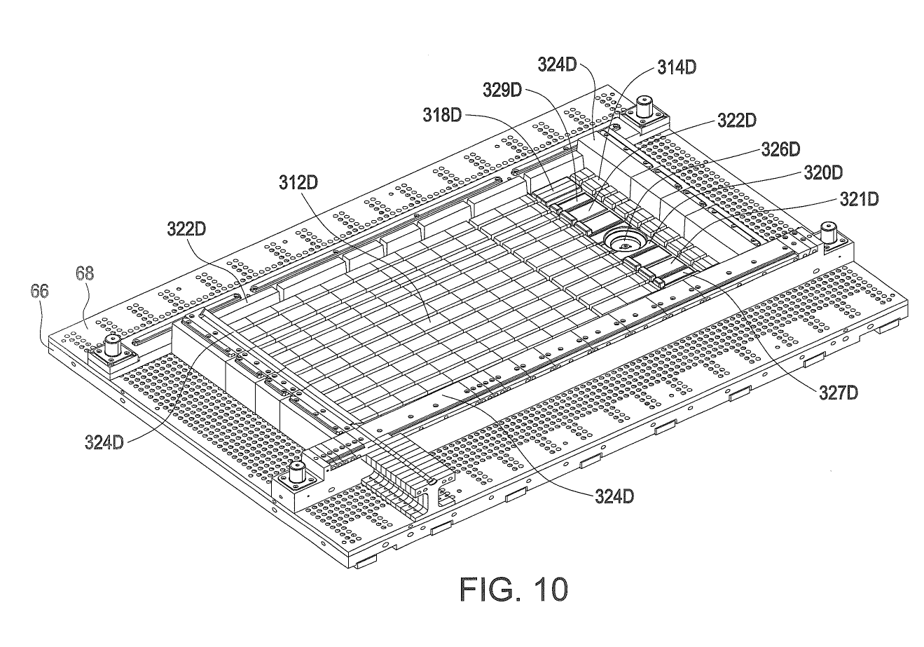

To that end, FIGS. 9-10 show an example of a completed tooling arrangement to manufacture a different workpiece from that manufactured by the tool halves shown in FIGS. 6-7, in this case a pre-fabricated waterproof shower pan having a linear trench with an integrally molded standard drain attached. As can be seen, drain locator plates 200AD and 200BD, as well as drain locator spacers 160 and 260, corresponding to the circular center drain shown in FIGS. 6-7 have been removed, and have been replaced by cavity and core pitched planar floor inserts 312C and 314C, cavity standard drain locator plates 326 C, 320C, core standard drain locator plates, 326D, and 320C, and cavity shower pan floor recess inserts 327C, 321C, 322C 329C, core side shower pan floor recess inserts 327D, 321D, 322D, and 329D corresponding to a linear trench with an standard drain integrally molded to the shower pan at the bottom of the linear trench, cavity side pitch inserts 316C, 318C, core side pitch inserts 316D, 318D, cavity entry curb inserts 322C and splashwall inserts 324C, and core entry curb inserts 322D and splashwall inserts 324D, installed on mounting plates 46, 66. Some of the tooling components 50 and 70 for zones 12A, 14A, 16A, 16AA 18A, 18AA, 20A, 21A, 22A, 24A, 25A, 12B, 14B, 16B, 16BB, 18B, 18BB, 20B, 21B 22B, 24B and 25B shown in FIGS. 1A and 1B are used in the tool of FIGS. 9-10, and some have been removed and replaced with others from a collection or universe of available inserts. In this example, it can be seen that a plurality of inserts 50, 70 are arranged in a pattern which creates workpiece-forming surfaces that, in turn, form a cavity in which molding material such as polymer resin is injected to form a shower pan having a linear drain. To create another workpiece that has some, but not all, of the same surface features as workpieces formed from the tool of FIGS. 9-10, some of the inserts are removed or relocated, and other inserts brought in to change the overall surface-forming shape of the collective inserts. Of course, all of the inserts used to make a first workpiece can be removed and replaced by an entire new set of inserts if an entirely different workpiece is going to be made. However, to the extent inserts can be used in the making of two or more different workpieces, valuable cost savings and manufacturing efficiencies are realized.

The zones shown in FIG. 1C correspond to the sets of inserts shown in FIG. 9 as follows:

| Zone | Insert Set/Grouping |
|---|---|
| 12C | 312C |
| 14C | 314C |
| 16C | 316C |
| 18C | 318C |
| 20C | 320C |
| 21C | 321C |
| 22C | 322C |
| 24C | 324C |
| 25C | 325C |

The zones shown in FIG. 1D correspond to the sets of inserts shown in FIG. 10 as follows:

| Zone | Insert Set/Grouping |
|---|---|
| 12D | 312D |
| 14D | 314D |
| 16D | 316D |
| 18D | 318D |
| 20D | 320D |
| 21D | 321D |
| 22D | 322D |
| 24D | 324D |
| 25D | 25D |

An example of a specific tooling arrangement which can be used to mold shower pans will now be discussed.

1. Assembly of Cavity and Core Sections of Tool

It should be noted that, as is the case with any part to be produced using the tooling apparatus and methods of this invention, the shape of two different parts which are produced from the same base tool may be vastly different, or may be very similar with only minor differences, or anything in between. The configuration and characteristics of the resulting workpiece will depend upon the selection and arrangement of the various inserts used in the cavity and core portions of the tool. In one embodiment, this invention contemplates the ability to make different workpieces by the use of multiple inserts variously configured where a different work piece is created by doing one or more of the following: (i) changing from one modular zone to another to permit a differently configured workpiece to be made; (ii) changing how a modular zone is positioned relative to another modular zone; (iii) changing the location of a modular zone on the mounting plates or the base/heating/cooling plates; (iv) changing any modular zone-specific inserts within any modular zone-; (v) changing the position of any modular zone-specific inserts relative to any other modular zone-specific inserts; (vi) changing the location of any modular zone-specific inserts on the mounting plates or the heating/cooling plates; (vii) using all, none, or some of the inserts from a specific modular zone; and (viii) taking inserts from one modular zone and using them as inserts in a different modular zone.

In the case of, for example, a prefabricated waterproof shower pan, a tool made and used in accordance with the principles of this invention may produce a pan having such features as, among others, a drain in a preselected location, a pan floor having a floor area that is pitched in only one direction or that has more than one area of pitch, sidewalls and an entrance which may be partially or completely curbed or without a curb for a barrier free entrance. By changing out one or more of the inserts from the tool, a second prefabricated waterproof shower pan can be manufactured which has some features that are identical to the first pan and other features which are entirely different, without the necessity of configuring an entirely new tool. For example, the second pan may have a different length and/or width, may have complete and or partial splash wall(s), and/or an entrance which may be curbed, partially curbed, a barrier free entrance, the entrance in a different location, height, width, and/or length, and/or may have the drain(s) located in different locations, may have a different drain type altogether, or any combination thereof. Therefore, one or more features may be present in one workpiece produced from the tool that are not present in another workpiece produced from the same tool.

Mounting plates 48, 68 as seen in FIG. 3 should be strong enough to support the core and cavity inserts when connected thereto without substantially flexing, and should be made of a material which will conduct heat rapidly. The mounting plates are provided with apertures for connecting the heating/cooling plates to the tool base/platens, as well as numerous apertures to receive fasteners for attaching inserts to the mounting plates to permit maximum flexibility when configuring a tool. Given the number of apertures which are made in plates 48, 68, the material out of which said plates are fabricated should be, in the preferred embodiment, stainless steel or the like.

As it is sometimes desired to move a feature of a work piece from a first location in a first work piece to a second location in a second work piece, such as moving the drain location in a shower pan, by a slight distance, but without creating an entirely new tool for the entire work piece, there are a number of expediencies that can be employed to change a zone of the tool to make such a change without disturbing the remainder of the tool (i.e., other zones). For example, the insert(s) used to create one or more curb sections can be moved from one side of the tool to the other to produce mirror image pans out of a single tool.

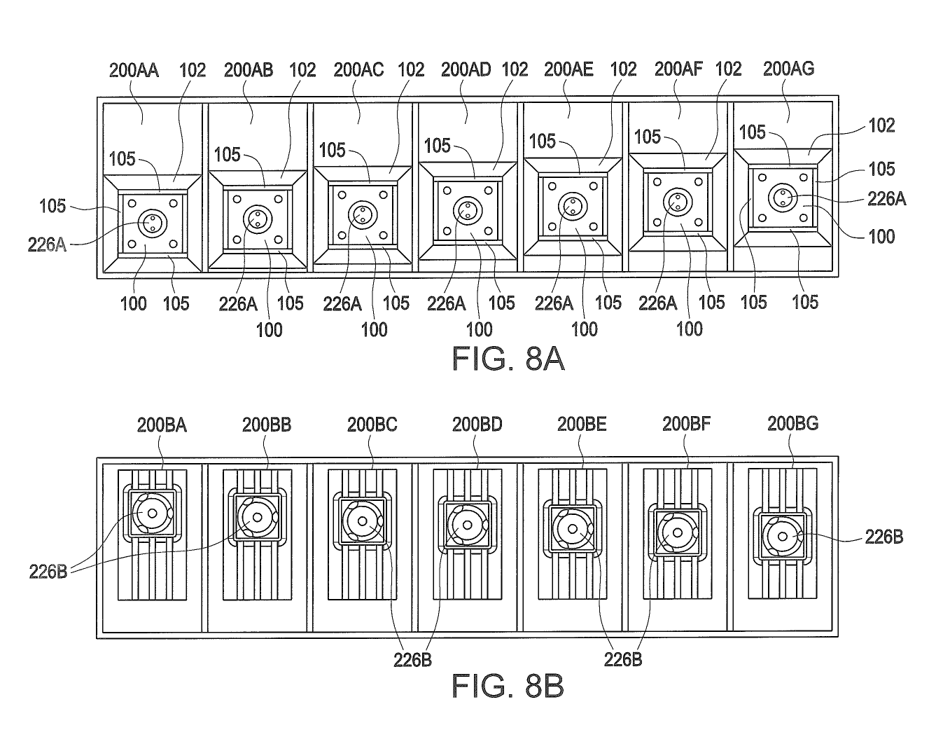

Another example, as seen in FIGS. 8A and 8B, is to employ cavity drain locator plates 200AA-200AG and core drain locator plates 200BA-200BG for this purpose. Each cavity drain locator plate 200AA-200AG has a drain location area 25A in a slightly different location, but any of which is adapted to create a drain structure (albeit with each being in a slightly different location) in the finished shower pan floor. As is seen in FIG. 8A, each successive cavity drain locator plate 200AA-200AG has drain location area 25A located in a different position, ranging from one plate where the drain opening is positioned near an end of drain locator plate 200AA to a position where drain location area 25A is positioned substantially in the center of drain locator plate 200AA. For example but not by way of limitation, the distance between the position of drain location area 25A in cavity drain locator plate 200AA and the position of drain location area 25 in cavity drain locator plate 200AB may be one inch. In this way, the location of drain area 25A, and the corresponding drain opening in the finished shower pan floor (not shown), can be varied in such increments (e.g. 1 inch) without changing any other feature of the tool, other than the corresponding aspect(s) of the cavity drain area zone 20A necessitated by the repositioning of the drain area 25A within the drain locator plates 200AA-200AG. The same applies to the core drain locator plates 200BA-200BG.

The location of the drain in any given shower pan is dictated by the location of the sewer pipe architecture of the space where the pan is to be installed. It has been found preferable, although not absolutely necessary, to first correlate the position of the drain in the pan relative to some feature of the pan to be created. As can be seen in FIG. 6, one way this can be done is by positioning one of cavity drain locator plates 200AA-200AG on cavity mounting plate 48 in a particular location on said mounting plate relative to one or more features of the mounting plate, such as one or more edges thereof. Cavity drain insert 25A may then be connected to a drain locator pitch ring 102, which in turn is positioned within area 25A of one of the drain locator plates 200AA-200AG.

Likewise, a core drain insert 25B is positioned relative to core mounting plate 68 in such a way as to cause the to-be-formed drain to be positioned in the tool in a location which is dictated by the architecture of the installation. Core drain insert 25B is positioned within area 25B of the core drain locator plate 200BA-200BG corresponding to the selected cavity drain locator plate 200AA-200AG, which in turn is connected to core mounting plate 68 in such a way as to locate the drain insert in the position of the to-be-formed drain (i.e., directly opposite the corresponding cavity drain locator plate). It is to be understood that the drain insert and/or actual drain to be molded into the shower pan may instead be connected to the cavity side of the tool without departing from the spirit or scope of the invention.

The tool embodiments shown in FIGS. 6-7 are set up to produce what can be referred to as a “center drain” pan (as opposed to “end drain,” “side drain,” “back drain” or “front drain” pans). In the cavity side of the tool, one of drain locator plates 200AA-200AG, having a drain insert 25A (and which also may employ removable adjustment structure such as drain locator pitch ring 102A and drain location adjusting shims 105A fitted therein, is connected to mounting plate 48 so that cavity drain insert 25A is located where the drain of the shower pan is to be located. In the core half of the tool, one of core drain locator plates 200BA-200BG, having a core drain insert 25B (and which also may employ removable adjustment structure such as drain locator pitch ring 102B and drain location adjusting shims 105B) fitted therein, is attached to core mounting plate 68. The drain locator pitch rings 102A and 102B will locate the drain inserts 25A, 25B in the cavity and will ideally have a pitch corresponding substantially to the pitch of adjacent floor areas I, III, VI and VIII (described supra). It should be noted that the location of the drain can be varied in any direction by any predetermined increment such as, by way of example but not by way of limitation, in ½ inch and ¼ inch increments by adjusting one or more of the location of the drain inserts 25A, 25B on the mounting plates or the base, by moving other zones on the mounting plates or bases, by moving the drain locator plate or substituting another drain locator plate, and/or by adjusting the drain spacers/shims 105A, 105B within the drain locator plates 200A, 200B. or using predrilled locator holes on certain drain inserts.

Cavity drain pitch transition insert zones 16A, 18A (FIG. 1A) are formed by the addition of cavity drain pitch transition inserts 160A and 180A as shown in FIG. 6. Cavity drain pitch transition inserts 160A and 180A are selected from a collection, group or “set” of pitch transition inserts which, when appropriate ones thereof are placed alongside the drain locator pitch ring 102, create areas 16A and 18A as multi-pitched shower pan floor surfaces. In other words, in the example shown, but not by way of limitation, the surface of zones 16A and 18A are non-planar. Depending upon the distance from drain locator pitch ring 102 to the edge of the outer most cavity drain transition inserts 160A and 180A, the drain transition inserts 160A and 180A are chosen from the available collection of such inserts to form a substantially smooth but multi-pitched workpiece surface forming area.

As seen in FIGS. 1A and 6, which show the cavity half of the tool, the grouping of inserts 160A and 180A, which are selected from the universe or “collection” of inserts which may be used to form zones 16A, 18A (see FIG. 1A), each form two separate multi-pitched areas. Insert grouping 160A forms non-coplanar floor areas denoted by Roman numerals I and II. Insert grouping 180A forms non-coplanar floor areas denoted by Roman numerals VII and VIII. Since, in the embodiment shown in FIG. 6, the drain location area 100 is in the center of the drain locator plate, the cavity drain locator plate used is plate 200AD shown in FIG. 8A, and pitched area III of said drain locator plate 200AD is substantially coplanar with the pitch of areas II and VII, as well the pitch of floor area 120A.

As also seen in FIGS. 1A and 6, the grouping of inserts 162A and 182A, which are selected from the universe or “collection” of inserts which may be used to form zones 16AA, 18AA (see FIG. 1A), each form two separate multi-pitched areas. Insert grouping 162A forms non-coplanar floor areas denoted by Roman numerals IV and V. Insert grouping 182A forms non-coplanar floor areas denoted by Roman numerals IX and X. Drain locator spacer 160 forms planar pitched area VI. Areas V, VI and X are coplanar with each other and with floor area 140A, and slope away from drain insert 25A.

As seen in FIGS. 1B and 7, which show the core half of the tool, the grouping of inserts 160B and 180B, which are selected from the universe or “collection” of inserts which may be used to form zones 16B, 18B (see FIG. 1B), each form two separate multi-pitched areas. Insert grouping 160B forms non-coplanar floor areas denoted by Roman numerals XI and XII. Insert grouping 180B forms non-coplanar floor areas denoted by Roman numerals XVII and XVIII. Since, in the embodiment shown in FIGS. 6 and 7, the drain location area 100 is in the center of the drain locator plate, the core drain locator plate used is plate 200BD shown in FIG. 8B, and pitched area XIII of said drain locator plate 200BD is substantially coplanar with the pitch of areas XII and XVII, as well the pitch of floor area 120B.

As seen in FIGS. 1B and 7, the grouping of inserts 162B and 182B, which are selected from the universe or “collection” of inserts which may be used to form zones 16BB, 18BB (see FIG. 1B), each form two separate multi-pitched pitched areas. Insert grouping 162B forms non-coplanar floor areas denoted by Roman numerals XIV and XV. Insert grouping 182B forms non-coplanar floor areas denoted by Roman numerals XIX and XX. Drain locator spacer 260 forms planar pitched area XVI. Areas XV, XVI and XX are coplanar with each other and with floor area 140B, and slope away from drain and drain insert 25B. The specific set or grouping of inserts which make up each zone are selected from an available collection of such inserts and should be chosen to create the desired workpiece surface contour.

As discussed previously and seen in FIGS. 8A and 8B, it is deemed expedient though not required to provide several cavity and core drain locator plates 200A, 200B in which may be positioned cavity and core drain inserts 25A, 25B. It has been found effective to provide several different cavity and core drain locator plates, each having a different drain insert aperture position (shown in FIGS. 8A and 8B) to accomplish the task of conveniently positioning the drain inserts 25A, 25B relative to the tool by simply swapping one drain insert locator plate with another when it is desired to move the position of the drain aperture slightly from one workpiece to the next.

For example, the use of a plurality of cavity drain insert locator plates, such as the seven plates shown as 200AA-200AG and a plurality of core insert drain locator plates, such as plates 200BA-200BG, acts to simplify the procedure of assembling and disassembling a tool by minimizing the amount of inserts necessary to position the drain insert in the precise location needed within any given drain assembly area 20, such as that shown in FIGS. 6-7. Drain locator plates 200A, 200B each define a drain insert area being located in a slightly different position on each plate. By “area” is meant the location where a drain insert is to be located during molding of a shower pan. Using cavity drain locator plate 200AA and corresponding core drain locator plate 200BA positions the respective drain insert areas in registry with each other when said plates are connected to their respective cavity and core halves of the tool. A simple technique for relocating the position of the drain in the workpiece by a slight amount from the locations dictated by the use of locator plates 200AA and 200BA is to select different core and cavity drain locator plates, such as locator plates 200AB and 200BB. As can be seen in FIGS. 8A and 8B, the drain insert areas 25A, 25B in plates 200AB and 200BB are in slightly different positions from the positions of drain insert areas 25A, 25B in drain locator plates 200AA and 200AC-200AG, and likewise for plates 200BA and 200BC-200BG, respectively. In addition, any of drain locator plates 200AA-AG and 200BA-BG can be rotated 180° before being added to the tool to add an additional six drain locations for the cavity and core halves of the tool. The cavity and core drain locator plates, in conjunction with the core and cavity shims 105, permit the drain to be moved in ½ inch or less increments in any direction. It is to be understood, however, that cavity drain locator plates 200AA-200AG, and/or core drain locator plates 200BA-200BG, may be dispensed with in favor of alternative specifically contoured inserts (not shown) selected and assembled in such a manner so as to create workpiece forming surfaces corresponding to the surfaces defined by the afore described locator plates 200AA-200AG and 200BA-200BG, and the drain shims 105 may also be dispensed with in favor of a different arrangement and/or methods for moving the drain, which will occur to those of skill in the art after having had the benefit of reading this disclosure. However, the use of facilities such as the disclosed drain locator plates, drain locator pitch rings 102A, 102B and/or drain shims 105A, 105B allows for a relatively small number of inserts to be used to vary the location of a feature (e.g. drain) from one workpiece to the next.

The surface contour of locator plates 200AA-200AG and 200BA-200BG, drain locator pitch ring 102 and the drain shims 105 may vary as do the locations of the drain inserts 25A, 25B.

The type and configuration of drain insert areas 25A, 25B of the drain locator plates 200AA-200AG and 200BA-200BG are shown by example only. Any type or location of drain area and drain fixture (not shown) is contemplated to be created by the tool and method of use disclosed herein, such as circular drains, linear drains, etc, located in any position on a pan floor, with the ability to locate the drain in the shower pan floor in any increments required by the customer or the market. It is to be understood, therefore, that any drain arrangement is possible with the tool of this invention.

In another step in the assembly of the tool, as seen in FIGS. 1A, 1B, 6, and 7, groupings of cavity and core drain pitch transition inserts and drain pitch extension inserts to create cavity areas 160A, 162A, 180A and 182A which are installed in cavity zones 16A, 16AA, 18A and 18AA, respectively, of FIGS. 1A and 6, and core areas 160B, 162B, 180B and 182BB are installed in core zones 16B, 16BB, 18B and 18BB, respectively, of FIGS. 1B and 7. The groupings of cavity and core drain pitch transition inserts and drain pitch extension inserts represented by cavity areas 160A, 162A, 180A and 182A, and core areas 160B, 162B, 180B and 182B, are selected from a series or collection of such inserts, the number in such groupings depending upon the particular location of the drain locator plates relative to the remainder of the workpiece to be created (in this case, by way of example but not limitation, a prefabricated waterproof shower pan). It can be seen that each one of successive cavity and core drain pitch transition inserts, respectively, has a slightly different surface contour and height, but when installed in the tool adjacent the cavity drain block zones 20A, 20B, and the drain block plates 21A, 21B, create the desired pitch in the drain pitch transition zones and areas shown in FIGS. 1A,1B, 6 and 7. Subsequent, or prior, to the installation of the cavity and core drain pitch transition inserts and the drain pitch extension inserts represented by the referenced cavity inserts 160A, 162A, 180A, 182A, and core inserts 160B, 162B, 180B, and 182B in zones 16A, 18A 16B and 18B, cavity and core constant pitch floor inserts represented by reference number 120A, 140A, 120B and 140B, respectively, are installed in the tool. These floor inserts, in the embodiment shown, create planar workpiece surfaces corresponding to areas 12A, 14A, 12B and 14B of FIGS. 1A and 1B that are pitched from the outer edges of the to-be-created floor of the shower pan toward the drain insert areas 16A, 18A and 20A of FIG. 1A and areas 16B, 18B and 20B of FIG. 1B. As in the case with the cavity and core drain pitch transition inserts and drain pitch extension inserts 160A, 162A, 180A, 182A, and the core and cavity drain block inserts 160B and 180B, the cavity and core constant pitch floor inserts represented by reference numbers 120A, 140A, 120B and 140B are selected from a set of available floor inserts to result in finished workpiece surfaces having the desired contour (e.g. constant pitch) from the lateral edges of the floor to the drain inserts.

In similar fashion, cavity and core entryway inserts corresponding to area 22A and 22B, respectively, of FIGS. 1A and 1B are attached to the tool halves, for example in the form of cavity curb wall insert block(s) 220A, 221A and core curb wall insert block(s) 220B so as to create an entryway curb. In order to create a different entryway, such as a barrier-free entryway, different cavity and core inserts (not shown) would be used, as would occur to one of skill in the art after having read the disclosure herein. Also, the height, width and length of the curb can be varied in the same manner.

At either end of the tool, gate and dump area inserts, respectively, which may simultaneously serve to form splash walls or any other workpiece-surface-forming feature, may be provided. Of course, the height, width and length of the splash wall can be varied.

A cavity side of an injection manifold is formed by attaching one or more cavity head blocks 190A and injection manifold blocks 191A, which form one half of a runner 192A, to the mounting plate 48 (or heating/cooling plate 46), which allows the injected polymer to flow through runner 192A into cavity gate area 195A and into the workpiece void. Corresponding cavity dump area inserts 197A (which may form a splashwall, curb or any other feature) permit venting of air and excess polymer from the opposite side of the tool during the injection process.

Likewise, a core side of an injection manifold is formed by attaching one or more injection manifold blocks 191B, which form runner the second half of a runner 192B, to the mounting plate 68 (or heating/cooling plate 66), which allows the injected polymer to flow through runner 192B into cavity gate area 195B and into the workpiece void. Corresponding cavity dump area inserts 197B permit venting of air and excess polymer from the opposite side of the tool during the injection process.

As discussed previously, the selection of the particular inserts used to create the tools shown in FIGS. 6 and 7 is by way of example only. The shape, size and component features of a tool used to form a waterproof prefabricated shower pan may be varied while still using the base tool, e.g. mounting plates 48, 68, heating/cooling plates 46, 66 and injection manifold (gate) area/dump area inserts 191A, 197A, 191B, 197B. All that is necessary is to select the appropriate inserts to create the desired workpiece features for any or all of the zones shown in FIGS. 1A-1H (or any other zones which may be used, which will occur to those of skill in the art after having had the benefit of understanding the disclosure herein).

2. Drain Locator Plates and Pitch Rings

Cavity drain locator pitch ring 102A is employed as a convenient vehicle to position cavity drain insert 25A relative to the drain block aperture defined by any one of drain locator plates 200AA-200AG. As best seen in FIG. 6, drain locator pitch ring 102A is placed in registry with cavity drain insert 25. It may be secured by fasteners such as bolts 103. It also may be located by the use of shims 105A to adjust its position slightly relative to pitch ring 102A, as well as drain locaters holes designed to easily relocate the drain not shown here. In addition, pitch ring 102A may define pitched workpiece-forming surfaces preferably corresponding to the pitch of areas I, III, VI, VIII.

3. Core Side Rib Forming Structure

In the preferred embodiment, the core side of the shower pan tool disclosed herein forms support ribs. In that embodiment, the ribs extend on the underside of the pan, with each rib preferably ending in a common plane to create a level support to contact the bathroom floor. The floor inserts form all or a portion of the ribs in the preferred embodiment. Any one or more of the pitch transition, curb (if applicable), sidewall and drain area inserts may or may not be shaped to create ribs as well.

As can be seen in FIG. 7, the floor inserts 120B and 140B collectively form longitudinal valleys or recesses V which become filled with polyurethane (or whatever material is used to create the pan) to form the support ribs. In the embodiment shown, the inserts in the drain pitch transition areas XI-XX also form rib recesses, as does the drain locator plate 200BA and as do the curb inserts 220B. These longitudinal rib recesses are substantially parallel to one another in the embodiment shown but may be in any orientation relative to one another and to the pan in general. Given the myriad possible combination of inserts in a given tool for a given workpiece, the recesses V in one area or zone of the core of the tool may not line up with the recesses V in an adjacent area or zone of the tool. If that were to happen, there would be an impediment to the flow of molten polyurethane (or other material used to form the pan) during injection. To overcome that potential problem, some or all of the inserts at the interface of two or more different zones or areas may be configured to create one or more transverse or cross recesses P, which fluidly communicate one or more longitudinal rib recesses V with other longitudinal rib recesses V, in which material may flow transversely to one or more other longitudinal recesses V, so that the material may fill the entirety of the recesses and other features of the pan.

This arrangement is used to allow the material to fill the full length of the ribs and all other features of the pan, even where it is impossible to line up the recesses V of the various adjacent inserts in different groupings (e.g. when using different inserts from each universe or collection of mold inserts).

Any pattern (i.e. orientation and shape) of ribs may be used. It is preferred but not necessary to put the ribs on the lowermost edge of the workpieces so that the material can easily flow from one set of parallel recesses V formed under one universe of inserts to another set of parallel valleys formed under another set of inserts. The techniques of this invention can be used to form ribs anywhere under the pan, and the ribs can be in any pattern throughout the length of the pan or any portion thereof, and the transverse/cross ribs between different sets of inserts make sure that the material can flow to and fill the ribs and other features of the pan.

It is to be understood that, while longitudinal recesses V and transverse recesses P are shown as perpendicular to each other in the drawings (FIGS. 7 and 10), they may also be orthogonal to each other but not perpendicular, or even parallel to the recesses V, so long as they join some or all of the valleys of adjacent zones. There may be different size inserts in each area of the tool, and ribs can be formed by any number of techniques, such as by a separate rib insert in certain circumstances and in other circumstances where the rib is placed on one or more of the inserts in a particular set. Also, there is discretion as to how frequently a separate rib insert can be employed. Also, the recesses V and/or P may be formed by adding recess-forming inserts to the underside of existing inserts.

It is, of course, to be understood that the bottom of any workpiece, such as a shower pan, manufactured using the teachings of this invention, may be completely or partially planar.

4. Other Components and Attachment Structure

As discussed above, any number and variety of components may be employed in the tool of the instant invention to create any number of varied workpieces.

The tool components/inserts 50, 70 may be attached to the heating plates 46, 66 or the mounting plates 48, 68 (if used) by any suitable means. As but one example, inserts 50 define threaded bores in the mounting plate-facing side thereof, such that bolts may be used to screwingly attach the inserts, individually, to mounting plates 48, 68. Inserts 50, 70, or any of them, may include locating pins which can be aligned with and inserted into corresponding apertures in mounting plates 48, 68 to releasably retain said inserts in position relative to the mounting plates while bolts are being used to connect the inserts to the mounting plates.

It is to be appreciated that many different workpieces may be formed using the single base tool as described herein. In the prefabricated shower pan example disclosed herein, such a tool allows for the manufacture of pans of any size and shape, and having any drain location or shape, with any size or shape curb or with no curb, and having any size splash walls or partial splash walls or no splash walls, using a minimal number of interchangeable inserts but one cavity and core base.

In addition, in the case where one or more mounting plates such as plates 48 and 68 is used, such plates allow for the attachment of any tool insert to any location within the tool without regard to the location of heating/cooling channels within the cavity and core heating plates 46, 66. Still further, more than one mounting plate may be employed in connection with any given workpiece or workpieces to be formed, to form one or more “modular zones,” such that two or more core mounting plates and/or two or more cavity mounting plates may be used to support sub-groupings of inserts used to manufacture any given workpiece, such that, to change features from one workpiece to the next, all that needs to be done is to remove one mounting plate, which has a sub-grouping of inserts mounted to it, and replace it with a substitute mounting plate, which has a different sub-grouping of inserts mounted to it, such that individual inserts need not be individually removed to change a feature or features of a workpiece/product.

Also, two or more mounting plates may be used simultaneously on either or both of the cavity and core sides of the tool. That is, a grouping of workpiece forming inserts can be assembled on a first mounting sub-plate corresponding to one portion of the workpiece to be formed, and another grouping of workpiece forming inserts can be assembled on a second mounting sub-plate corresponding to a different portion of the workpiece to be formed, and together the inserts on both mounting sub-plates make up the entirety of the grouping of inserts used to manufacture a given workpiece. This can be performed on either or both of the cavity and core sides of the tool, and any number of mounting plates (i.e., two or more) can be used on either the cavity and/or core side. Such an arrangement will make it easier to change sets of inserts when changing the tool from one workpiece to another having some but not all surface features in common with the first workpiece, as not all of the inserts will have to be changed. And, by using mounting sub-plates to create modular zones, the number of individual inserts that have to be removed is reduced in some instances, and more than one insert can be removed from the tool by simply removing one sub-plate which has a multiplicity of inserts connected thereto. One benefit to using mounting sub-plates is that one can leave the inserts on any given sub-plate intact upon removal of that sub-plate from the tool, install another sub-plate with a different sub-grouping of inserts thereon, use that other sub-plate, remove it, and then reinstall the first sub-plate, allowing for the modification of workpieces using a single tool without ever having to remove an individual insert. Another benefit of the use of mounting sub-plates is that the size of the mounting sub-plate could be such that it is designed to be used alone to make specific workpieces when used in one circumstance, but it is also designed to be used in conjunction with one or more other sub-plates, when making a different workpiece or set of workpieces, This would be particularly true where the mounting sub-plates are used to extend the length, width, or both of the primary mounting plates in order to make larger or smaller workpieces. Similarly, heating/cooling sub plates and extension plates can be used in the same fashion.

Also, two or more mounting plates may be used to permit different size parts to be manufactured. At first set of mounting plates may be designed to make a broad range of workpieces. A second set of mounting plates may be designed to be used in conjunction with such first set of mounting plates by allowing wider workpieces to be made, longer work pieces to be made, or both to be made, when the mounting plates are used in combination. This permits a broader range of workpieces to be manufactured with a smaller cost associated with the mounting plates. Also, it permits different combinations of plates to be used for different size press.

It is also contemplated that by the teaching of this invention that modular sets of heating/cooling plates shall be used in conjunction with the modular sets of mounting plates and/or having the inserts attached directly to the modular sets of heating/cooling plates. Even further, the mounting plates may have heating and/or cooling capabilities integral thereto, such as resistance heating elements and/or channels for the passage of heat transfer media, in addition, or alternatively to, the heating and cooling plates.

In addition, trench pans are easily adaptable for use with tools of the instant invention so that any size shower pan with a recessed trench in the shower pan floor and a standard drain integrally molded to the trench, or a trench drain molded into the trench floor, can be made with any drain location, any size or shape trench, and any trench location. The trench pans are compatible with the shower pan floor recess inserts, with curb or barrier free entrance inserts, with linear trench inserts of any shape or size, square trench inserts of any size or shape, round trench inserts of any size, drain pitch transition inserts, standard drain inserts, floor inserts, curb inserts and splash wall inserts. To do so, a collection or collections of inserts that can be incorporated into the core and cavity halves of the tool are provided.

A method of creating a shower pan having a trench recess feature is contemplated, comprising the steps of: providing a collection of cavity-side trench recess shower pan inserts, selecting a grouping of cavity-side trench recess inserts which will be used to create the cavity side of the tool, each being detachably securable to the cavity-side mounting plate at any one of a multiplicity of user-selected locations, each of said cavity-side trench recess inserts having at least a mounting side which faces said cavity mounting plate when connected thereto, and a workpiece-forming surface which defines at least a portion of a cavity-side of said trench recess feature; providing a collection of core-side trench recess inserts, selecting a grouping of core-side trench shower pan inserts which will be used to create the core side of the tool, each being detachably securable to said core-side mounting plate at any one of a multiplicity of user-selected locations on said core-side mounting plate, each of said core-side trench shower pan inserts having at least a mounting side which faces said core mounting plate when connected thereto, and a workpiece-forming surface which defines at least a portion of a core side of said trench recess feature. The trench recess shower pans contemplate any shape recesses including but not limited to shapes such as square trench recess shower pans, rectangular, linear trench recess shower pans and round recesses.

In addition, Neo angle floor and curb inserts are easily adaptable for use with tools of the instant invention so that any size Neo angle pans can be made with Neo angle floor and curb or barrier free entrance inserts. Such Neo inserts are also compatible with linear trench inserts of any shape or size, square trench inserts, drain pitch transition inserts, standard drain inserts, floor inserts, curb inserts and splash wall inserts. It is desirable to incorporate features such as Neo-angles and Neo rounds and recesses for trenches and drains with the pans as the pans are molded. To do so, a collection or collections of inserts that can be incorporated into the core and cavity halves of the tool are provided. A method of creating a shower pan having a Neo-angle feature is contemplated, comprising the steps of: providing a collection of cavity-side Neo-angle inserts, selecting a grouping of cavity-side Neo-angle inserts which will be used to create the cavity side of the tool, each being detachably securable to the cavity-side mounting plate at any one of a multiplicity of user-selected locations, each of said cavity-side Neo-angle inserts having at least a mounting side which faces said cavity mounting plate when connected thereto, and a workpiece-forming surface which defines at least a portion of a cavity-side of said Neo-angle feature; providing a collection of core-side Neo-angle inserts, selecting a grouping of core-side Neo-angle inserts which will be used to create the core side of the tool, each being detachably securable to said core-side mounting plate at any one of a multiplicity of user-selected locations on said core-side mounting plate, each of said core-side Neo-angle inserts having at least a mounting side which faces said core mounting plate when connected thereto, and a workpiece-forming surface which defines at least a portion of a core side of said Neo-angle feature. The Neo shower pans contemplate shapes such as Neo angle square shower pans, Neo angle rectangular shower pans, and Neo-round square shower pans. and Neo-round rectangular shower pans

Angle cutoff pans and curb inserts are also easily adaptable with the existing tool inserts so that any size angle cutoff pans with any angle can be made with angle cutoff floor and curb or barrier free entrance inserts. These angle cutoff pans are also compatible with the linear trench inserts, the standard drain inserts, and the square trench inserts. To do so, a collection or collections of inserts that can be incorporated into the core and cavity halves of the tool are provided. A method of creating a shower pan having a angle cutoff feature is contemplated, comprising the steps of: providing a collection of cavity-side angle cutoff inserts, selecting a grouping of cavity-side angle cutoff inserts which will be used to create the cavity side of the tool, each being detachably securable to the cavity-side mounting plate at any one of a multiplicity of user-selected locations, each of said cavity-side angle cutoff inserts having at least a mounting side which faces said cavity mounting plate when connected thereto, and a workpiece-forming surface which defines at least a portion of a cavity-side of said angle cutoff feature; providing a collection of core-side angle cutoff inserts, selecting a grouping of core-side angle cutoff inserts which will be used to create the core side of the tool, each being detachably securable to said core-side mounting plate at any one of a multiplicity of user-selected locations on said core-side mounting plate, each of said core-side angle cutoff inserts having at least a mounting side which faces said core mounting plate when connected thereto, and a workpiece-forming surface which defines at least a portion of a core side of said angle cutoff feature.

Moreover, it is desirable to incorporate features such as drain recesses into shower pans which are manufactured in accordance with the teachings of the invention so that any type of drain apparatus may be incorporated into the pans, and this can be implemented by a process which includes the steps of: providing a collection of cavity-side drain recess inserts, selecting a grouping of cavity-side drain recess inserts which will be used to create the cavity side of the tool, each being detachably securable to the cavity-side mounting plate at any one of a multiplicity of user-selected locations, each of said cavity-side drain recess inserts having at least a mounting side which faces said cavity mounting plate when connected thereto, and a workpiece-forming surface which defines at least a portion of a cavity-side of said drain recess; providing a collection of core-side drain recess inserts, selecting a grouping of core-side drain recess inserts which will be used to create the core side of the tool, each being detachably securable to said core-side mounting plate at any one of a multiplicity of user-selected locations on said core-side mounting plate, each of said core-side drain recess inserts having at least a mounting side which faces said core mounting plate when connected thereto, and a workpiece-forming surface which defines at least a portion of a core side of said drain recess.

Similar methods can be implemented for curbs and/or barrier free entryways, splashwalls, and any other features.

5. Constant Pitch Floor Sections

A significant benefit to the use of the apparatus and methods disclosed herein is the ability to create many different sized workpieces, such as shower pans, using a minimal number of components, which can be used in countless different types of workpieces, and in countless different configurations with a particular type of workpiece. For workpieces having significant portions thereof that are constant across many different varieties of such workpieces, such as prefabricated shower pans, where the drain location may differ across many varieties but substantial sections of floor are planar in all varieties, the same tooling components that are used to make a planar floor section in one variety can be used to make planar floor sections in any number of varieties. This in turn results in substantial savings in tooling costs, as only one set of such tooling components need be made, yet that same set can be used to create a large number of workpieces.

The same holds true for any of the other constant-feature areas of any workpiece. The ability to use the same tooling components for many different products allows for a minimal number of tool components to be made.

Shower pans of any size, drain location, shape or features can be made by varying the selection of cavity and core-side inserts connected to the cavity and core bases, respectively. For example, at least one cavity-side drain insert and one core-side drain insert should be used to integrate a drain into the shower pan. In such an example, cavity and core-side drain inserts correspond to, such that they result in the integration into the shower pan of, at least one drain selected from a group of drains consisting of linear drains, standard drains, circular drains, PVC drains and cast iron drains. As another example, at least one cavity-side sidewall insert and one core-side sidewall insert for integrating the sidewall into the shower pan may be provided in the collection of cavity and core-side inserts. The cavity and core-side sidewall inserts correspond to, such that they result in the integration into the shower pan of, at least one sidewall selected from a group of sidewalls consisting of splashwalls, barrier free entryways and curbs. The collection of cavity and core-side sidewall inserts which are adapted to be used in the invention are sized and shaped in such a manner that they can be combined in the tool in a wide variety of configurations so as to create one or more sidewalls of desired height and width to fit any pan size and feature parameters.

As a further example, at least one cavity-side floor insert and one core-side floor insert for integrating a floor into the shower pan should be provided in the collection of cavity and core-side inserts. The cavity and core-side floor inserts correspond to, such that they result in the integration into the shower pan of, at least one floor section which is selected from a group of floor sections consisting of exclusively planar floor sections, partially planar floor sections and floor sections which are comprised of planar and V-pitched floor sections. By “V-pitched floor section” is meant a floor section which includes a first area which resides in a first plane and a second area, adjacent to the first area, which resides in a second plane, the first and second planes being orthogonal to each other. The collection of cavity and core-side floor inserts which are adapted to be used in the invention are sized and shaped in such a manner that they can be combined in the tool in a wide variety of configurations so as to create one or more floors of desired length, width and topography to fit any pan size and feature parameters.

Likewise, cavity and core curb inserts Neo curb inserts, splash wall inserts, barrier free entrance inserts, Neo barrier free inserts, drain inserts for standard drain pans, inserts that create recesses in the pan of any shape, dimension, and location, including but not limited to linear recesses of any shape or location, e.g. differently sized and located square and/or rectangular recesses, are contemplated to be includable in the universe of inserts available for use in manufacturing shower pans in accordance with this invention.

Since the surface contour of a shower pan must be conducive to the drainage of shower waste water and the expedient installation of tile thereon, transitioning from one workpiece feature (e.g. floor zones 12A, 14A, 12B and 14B) to another (e.g. drain zones 20A, 21A, 20B and 21B) is crucial. Another transition area is the area between the drain locator plate inserts and the drain pitch transition inserts. Therefore, it is preferable to incorporate collections of inserts which are specifically designed to create the most effective transition areas. Collections of transition-specific inserts may be employed with tools for manufacturing any type of workpieces that have more than one feature-consistent area or zone and which is capable of being used to manufacture more than one workpiece.

6. Methods for Manufacturing Workpieces

A method of creating two or more workpieces from a single base tool using modular workpiece surface-forming inserts is contemplated, comprising:

providing a cavity base which is adapted to receive a first grouping of cavity-side inserts, which first grouping of cavity-side inserts, when associated with the cavity base, creates a first cavity-side workpiece-forming surface;

providing a core base which is adapted to receive a first grouping of core-side inserts, which first grouping of core-side inserts, when associated with the core base, creates a first core-side workpiece-forming surface;

providing a collection of cavity-side inserts from which the first grouping of cavity-side inserts is selected;

providing a collection of core-side inserts from which the first grouping of core-side inserts is selected;

associating the first grouping of cavity-side inserts with the cavity base;

associating the first grouping of core-side inserts with the core base;

mating the core and cavity bases together and molding a first workpiece;

disassociating, i.e., removing, one or more of the first grouping of cavity-side inserts from the cavity base, and disassociating, i.e., removing, one or more of the first grouping of core-side inserts from the core base;

associating a second grouping of cavity-side inserts from the collection of cavity-side inserts with the cavity base;

associating a second grouping of core-side inserts from the collection of core-side inserts with the core base;

mating the core and cavity bases together and molding a second workpiece;

wherein the first and second workpieces have at least one surface feature that is different from the other.

A method for injection molding a variety of differently configured prefabricated shower pans using a single base tool is also contemplated, said shower pans being characterized as having one or more of at least the following: one or more planar floor areas and/or one or more drains areas, the tool including at least one cavity heating/cooling plate and at least one core heating/cooling plate, comprising:

providing a collection of cavity-side floor inserts, each being detachably securable to the cavity-side heating/cooling plate at any one of a multiplicity of user-selected locations, each of said cavity-side floor inserts having at least a mounting side which faces said cavity-side heating/cooling plate when connected thereto, and a workpiece-forming surface which defines at least a portion of a cavity-side of said floor, said workpiece-forming surface of each cavity-side floor insert being substantially planar;

providing a collection of core-side floor inserts, each being detachably securable to said core-side heating/cooling plate at any one of a multiplicity of user-selected locations on said core-side heating/cooling plate, each of said core-side floor inserts having at least a mounting side which faces said core-side heating/cooling plate when connected thereto, and a workpiece-forming surface which defines at least a portion of a core side of said floor;

providing a collection of cavity-side drain area inserts, each being detachably securable to said cavity-side heating/cooling plate at any one of a multiplicity of user-selected locations, each of said cavity-side drain inserts having at least a mounting side which faces said cavity-side heating/cooling plate when connected thereto, and a workpiece-forming surface which defines at least a portion of a cavity-side of the drain area to be formed in said shower pan;

providing a collection of core-side drain area inserts, each being detachably securable to said core-side heating/cooling plate at any one of a multiplicity of user-selected locations, each of said core-side drain inserts having at least a mounting side which faces said core-side heating/cooling plate when connected thereto, and a workpiece-forming surface which defines at least a portion of a core-side of the drain area to be formed in said shower pan;

selecting a first grouping of cavity-side floor inserts from the collection of cavity-side floor inserts which collectively correspond in workpiece surface-forming characteristics to a desired shape of at least a portion of an upper surface of the floor of a first shower pan;

selecting a first grouping of core-side floor inserts from the collection of core-side floor inserts which collectively correspond in workpiece surface-forming characteristics to at least a portion of a desired shape of a lower surface of the floor of a first shower pan;

selecting a first grouping of cavity-side drain area inserts from the collection of cavity-side drain inserts which collectively correspond in workpiece surface-forming characteristics to a desired shape of an upper surface of the drain of a first shower pan;

selecting a first grouping of core-side drain area inserts from the collection of core-side drain inserts which collectively correspond in workpiece surface-forming characteristics to a desired shape of a lower surface of the drain of a first shower pan;

associating the first grouping of cavity-side floor inserts with the cavity-side heating/cooling plate;

associating the first grouping of core-side floor inserts with the core-side heating/cooling plate;

associating the first grouping of cavity-side drain area inserts with the cavity-side heating/cooling plate;

associating the first grouping of core-side drain area inserts with the core-side heating/cooling plate;

mating the core and cavity heating/cooling plates together and molding said first pan;

removing at least some of either or both of the first grouping of cavity-side floor and drain area inserts from the cavity heating/cooling plate, and removing at least some of either or both of the first grouping of core-side floor and drain inserts from the core heating/cooling plate;

selecting a second grouping of cavity-side floor and/or drain area inserts from the collection of cavity-side inserts which collectively correspond in workpiece surface-forming characteristics to a desired shape of an upper surface of a second shower pan;

selecting a second grouping of core-side floor and/or drain area inserts from the collection of core-side inserts which collectively correspond in workpiece surface-forming characteristics to a desired shape of a lower surface of a second shower pan;

associating the second grouping of cavity-side floor and/or drain area inserts with the cavity heating/cooling plate;

associating the second grouping of core-side floor and/or drain area inserts with the core heating/cooling plate;

mating the core and cavity heating/cooling plates together and molding a second workpiece

wherein the first and second pans have at least one surface feature that is different from the other.

As discussed above, the apparatus used to provide the aforedescribed method my include an injection molding press having cavity and core platens, and cavity and core heating/cooling plates. Moreover, and in addition, such apparatus may or may not also employ one or more cavity-side mounting plate and one or more core-side mounting plate. As discussed above, the one or more mounting plates, if employed, are used to connect the inserts to the heating/cooling plates. Therefore, the methods of creating workpieces contemplated by this invention may then include sandwiching the cavity and/or core mounting plate(s) between the respective cavity and core inserts and the respective cavity and core heating/cooling plates.

The method described above may be practiced with any number of workpiece features, such as one or more curbs or barrier free entrances, one or more shower floor recesses and one or more splashwalls and/or sidewalls. Practicing the invention with feature-consistent areas which are alternative or additional to these features, or any other alternative or additional features, merely requires providing a collection of inserts which can be used to make a portion of such feature-consistent area, selecting some or all of such inserts and associating them with the respective cavity and core heating/cooling plates, molding one or more first workpieces, disassociating some or all of said inserts, and replacing the removed inserts with other inserts from the collection of possible inserts associated with said area(s), and molding one or more second workpieces.

By “associating” inserts with the cavity and/or core bases is meant attaching said inserts directly to the respective cavity or core base (or bases in the event that either or both of the cavity and core bases are made up of sub-bases), or attaching said inserts to one or more mounting plates, which mounting plates are in turn attached directly to the respective cavity or core base (or bases in the event that either or both of the cavity and core bases are made up of sub-bases).

Numerous additional workpiece features, such as those discussed throughout this disclosure, can be created by modifying the manufacturing method set forth above and in the claims, which are incorporated into this disclosure as if fully set forth herein.

Also, it is preferable to make most or all of the inserts compatible with other inserts and with inserts from additional tools to provide the greatest flexibility to make the greatest variety of work pieces from the fewest number of inserts.

Finally while not necessary, it is preferable to make all of the pieces compatible with other pieces and additional tools to provide the greatest flexibility to make the greatest variety of work pieces from the fewest number of inserts, mounting plates, and heating/cooling plates. For example, one can view a tool of this invention as one complete design that allows one to produce one set of parts at a time from one tool. But also, as one expands the number of presses used so that multiple workpieces can be made concurrently, one can simply duplicate the insert universe or sub-universe so as to view the tools as separate sets of tools, but also one can view all of the inserts, mounting plates and cooling/heating plates as one collective tool that can support any number of presses by creating different inserts that are all interchangeable with mounting plates and heating/cooling plates and compatible with multiple presses, so that the operator of the tool(s) doesn't have to duplicate the pieces that are not used that frequently because he/she may already have several of them, and it also allows one to expand the capability of the tool, by inventorying more than one of the most frequently used inserts. Alternatively, it may also be preferable under certain circumstances to have a smaller or larger number of certain inserts for certain zones, together with smaller or larger versions of the mounting plates and heating/cooling plates for purposes of allowing either or both of less popular or more popular parts to be made at a smaller tooling cost. Accordingly, it should be noted that this invention allows for the modularization of an injection molding press, such that any configuration or size of inserts can be used in virtually any combination or sub-combination desired by simply varying the size and/or shape of the mounting sub-plates and/or the heating/cooling plates.

As the tools and collections/groupings of inserts evolve and expand, one can also make different/additional inserts than the ones that were initially designed because, for example, one may want to have different inserts that permit configurations that are easier to assemble. For example, the size (i.e., width, height, length and/or surface contour) of any given insert can be increased or decreased or be provided with an additional feature or features. In essence, the teachings of this invention contemplate the modular use of any number of different categories of inserts to make unlimited custom workpieces/parts.

It should also be appreciated that the teachings of this invention may be applied to any molding technology, such as vacuum forming, blow molding, etc., as will occur to one of skill in the relevant art after having had the benefit of the teachings hereof.

Benefits, other advantages, and solutions to problems have been described above with regard to specific embodiments of the present invention. However, the benefits, advantages, solutions to problems, and any element(s) that may cause or result in such benefits, advantages, or solutions to become more pronounced are not to be construed as a critical, required, or essential feature or element of any or all the claims. The invention is defined solely by the appended claims including any amendments made while this application is pending and all equivalents of those claims as issued.

1. A method of creating two or more workpieces from a single base tool using modular workpiece surface-forming inserts, comprising:
providing one or more cavity bases which are adapted to receive a first grouping of cavity-side inserts, which first grouping of cavity-side inserts, when associated with the one or more cavity bases, creates a first cavity-side workpiece-forming surface;
providing one or more core bases which are adapted to receive a first grouping of core-side inserts, which first grouping of core-side inserts, when associated with the one or more core bases, creates a first core-side workpiece-forming surface;
providing a collection of cavity-side inserts from which the first grouping of cavity-side inserts is selected;
providing a collection of core-side inserts from which the first grouping of core-side inserts is selected;
associating the first grouping of cavity-side inserts with the cavity base;
associating the first grouping of core-side inserts with the core base;
mating the one or more core and cavity bases together and molding a first workpiece;
removing one or more of the first grouping of cavity-side inserts from the one or more cavity bases, and removing one or more of the first grouping of core-side inserts from the one or more core bases;
associating a second grouping of cavity-side inserts from the collection of cavity-side inserts with the one or more cavity bases;
associating a second grouping of core-side inserts from the collection of core-side inserts with the one or more core bases;
mating the one or more core and cavity bases together and molding a second workpiece.

2. The method of claim 1, wherein the step of associating the first grouping of cavity-side inserts with the one or more cavity-bases includes connecting the first grouping of cavity-side inserts to one or more cavity-side mounting plates, and connecting the cavity-side mounting plate to one or more cavity-side heating/cooling plates, and
wherein the step of associating the first grouping of core-side inserts with the one or more core bases includes connecting the first grouping of core-side inserts to one or more core-side mounting plates, and connecting the one or more core-side mounting plates to one or more cavity-side heating/cooling plates.

3. A method of creating two or more workpieces from a single base tool using solely modular components, comprising:
providing one or more cavity bases which are adapted to receive a first grouping of cavity-side inserts which, when associated with the one or more cavity bases, create a first cavity-side workpiece-forming surface;
providing one or more core bases which are adapted to receive a first grouping of core-side inserts which, when associated with the one or more core bases, create a first core-side workpiece-forming surface;
providing a collection of cavity-side inserts from which the first grouping of cavity-side inserts is selected;
providing a collection of core-side inserts from which the first grouping of core-side inserts is selected;
associating the first grouping of cavity-side inserts with the cavity base;
associating the first grouping of core-side inserts with the core base;
mating the one or more core and cavity bases together and molding a first workpiece;
removing one or more of the first grouping of cavity-side inserts from the one or more cavity bases, and removing one or more of the first grouping of core-side inserts from the one or more core bases;
replacing the removed one or more cavity-side inserts from the first grouping of cavity-side inserts with one or more inserts from the collection of cavity-side inserts, and replacing the removed one or more core-side inserts from the first grouping of core-side inserts with one or more inserts from the collection of core-side inserts;
mating the one or more core and cavity bases together and molding a second workpiece, the first and second workpieces having at least one surface feature in common and having at least one surface feature different from one another.

4. The method of claim 3, wherein the one or more cavity bases is/are a molding tool component through which is adapted to be passed one or more heat transfer media adapted to heat and/or cool the cavity-side inserts.

5. The method of claim 3, wherein the one or more core bases is/are a molding tool component through which is adapted to be passed one or more heat transfer media adapted to heat and/or cool the core-side inserts.

6. A method for injection molding a variety of differently configured prefabricated shower pans using a single base tool, said shower pans being characterized as having one or more of at least the following: one or more planar floor areas, one or more drain areas, one or more curbs or barrier free entrances, and one or more splashwalls and/or sidewalls, comprising:
providing one or more of a group of cavity-side tool insert mounting members consisting one or more cavity-side mounting plates and one or more cavity-side heating/cooling plates;
providing one or more of a group of core-side tool insert mounting members consisting of one or more core-side mounting plates and one or more core-side heating/cooling plates;
providing a collection of cavity-side floor inserts, each being detachably securable to said one or more cavity-side mounting members at any one of a multiplicity of user-selected locations, each of said cavity-side floor inserts having at least a mounting side which faces said one or more cavity mounting members when connected thereto, and a workpiece-forming surface which defines at least a portion of a cavity-side of said floor to be formed in said shower pans, said workpiece-forming surface of each cavity-side floor insert being substantially planar;
providing a collection of core-side floor inserts, each being detachably securable to said one or more core-side mounting members at any one of a multiplicity of user-selected locations, each of said core-side floor inserts having at least a mounting side which faces said one or more core mounting members when connected thereto, and a workpiece-forming surface which defines at least a portion of a core side of said floor to be formed in said shower pans;
providing a collection of cavity-side drain area inserts, each being detachably securable to said one or more cavity-side mounting members at any one of a multiplicity of user-selected locations, each of said cavity-side drain inserts having at least a mounting side which faces said one or more cavity-side mounting when connected thereto, and a workpiece-forming surface which defines at least a portion of a cavity-side of a drain area to be formed in said shower pan;
providing a collection of core-side drain area inserts, each being detachably securable to said one or more core-side mounting members at any one of a multiplicity of user-selected locations, each of said core-side drain inserts having at least a mounting side which faces said one or more core-side mounting members when connected thereto, and a workpiece-forming surface which defines at least a portion of a core-side of the drain area to be formed in said shower pan;
selecting a first grouping of cavity-side floor inserts from the collection of cavity-side floor inserts, which grouping collectively corresponds in workpiece surface-forming characteristics to a desired shape of at least a portion of an upper surface of the floor of a first shower pan;
selecting a first grouping of core-side floor inserts from the collection of core-side floor inserts, which grouping collectively corresponds in workpiece surface-forming characteristics to at least a portion of a desired shape of a lower surface of the floor of a first shower pan;
selecting a first grouping of cavity-side drain area inserts from the collection of cavity-side drain inserts, which grouping collectively corresponds in workpiece surface-forming characteristics to a desired shape of an upper surface of the drain a drain area of a first shower pan;
selecting a first grouping of core-side drain area inserts from the collection of core-side drain inserts, which grouping collectively corresponds in workpiece surface-forming characteristics to a desired shape of a lower surface of the drain area of a first shower pan;
associating the first grouping of cavity-side floor inserts with the cavity base;
associating the first grouping of core-side floor inserts with the core base;
associating the first grouping of cavity-side drain area inserts with the cavity base;
associating the first grouping of core-side drain area inserts with the core base;
mating the core and cavity bases together and molding said first pan;
disassociating at least some of either or both of the first grouping of cavity-side floor and drain area inserts from the cavity base, and disassociating at least some of either or both of the first grouping of core-side floor and drain area inserts from the core base;
selecting a second grouping of cavity-side floor and/or drain area inserts from the collection of cavity-side inserts which collectively correspond in workpiece surface-forming characteristics to a desired shape of an upper surface of a second shower pan;
selecting a second grouping of core-side floor and/or drain area inserts from the collection of core-side inserts which collectively correspond in workpiece surface-forming characteristics to a desired shape of a lower surface of a second shower pan;
associating the second grouping of cavity-side floor and/or drain area inserts with the cavity base;
associating the second grouping of core-side floor and/or drain area inserts with the core base;
mating the core and cavity bases together and molding a second workpiece;
wherein the first and second pans have at least one floor and/or drain area surface feature that is different from the other.

7. The method of claim 6, further comprising:
providing a collection of cavity-side splash wall inserts, each being detachably securable to the one or more cavity-side mounting members at any one of a multiplicity of user-selected locations, each of said cavity-side splash wall inserts having at least a mounting side which faces said one or more cavity mounting members when connected thereto, and a workpiece-forming surface which defines at least a portion of a cavity-side of said splash wall to be formed in said shower pans;
providing a collection of core-side splash wall inserts, each being detachably securable to said one or more core-side mounting members at any one of a multiplicity of user-selected locations, each of said core-side splash wall inserts having at least a mounting side which faces said one or more core-side mounting members when connected thereto, and a workpiece-forming surface which defines at least a portion of a core side of said splash wall to be formed in said shower pans;
selecting a first grouping of cavity-side splash wall inserts inserts from the collection of cavity-side splash wall inserts which collectively correspond in workpiece surface-forming characteristics to a desired shape of an upper surface of a splash wall of a first shower pan;
selecting a first grouping of core-side splash wall inserts inserts from the collection of core-side splash wall inserts which collectively correspond in workpiece surface-forming characteristics to a desired shape of a lower surface of a splash wall of a first shower pan;
associating the first grouping of cavity-side splash wall inserts with the one of more cavity-side mounting members;
associating the first grouping of core-side splash wall inserts with the one or more core side mounting members;
mating the core-side and cavity-side mounting members together and molding said first pan;
disassociating at least some of the first grouping of splash wall inserts from the one or more cavity-side mounting members, and disassociating at least some of the first grouping of core-side splash wall inserts from the one or more core-side mounting members;
selecting a second grouping of cavity-side splash wall inserts from the collection of cavity-side splash wall inserts which collectively correspond in workpiece surface-forming characteristics to at least a portion of a desired shape of an upper surface of a splash wall feature of a second shower pan;
selecting a second grouping of core-side splash wall inserts from the collection of core-side splash wall inserts which collectively correspond in workpiece surface-forming characteristics to a desired shape of at least a portion of a lower surface of a splash wall feature of a second shower pan;
associating the second grouping of cavity-side splash wall inserts with the one or more cavity—side mounting members;
associating the second grouping of core-side splash wall inserts with the core-side mounting members;
mating the core-side and cavity-side mounting members together and molding a second pan;
wherein the first and second pans have at least one splash wall feature that is different from the other.

8. The method of claim 6, further comprising:
providing a collection of cavity-side entrance inserts selected from a group consisting of curb and barrier free entrance inserts, each entrance insert being detachably securable to the one or more cavity-side mounting members at any one of a multiplicity of user-selected locations, each of said cavity-side entrance inserts having at least a mounting side which faces said one or more cavity-side mounting members when connected thereto, and a workpiece-forming surface which defines at least a portion of a cavity-side of said curb and/or barrier free entrance to be formed in said pans;
providing a collection of core-side entrance inserts selected from a group consisting of curb and barrier free entrance inserts, each entrance insert being detachably securable to said one or more core-side mounting members at any one of a multiplicity of user-selected locations, each of said core-side entrance inserts having at least a mounting side which faces said one or more core mounting members when connected thereto, and a workpiece-forming surface which defines at least a portion of a core side of said curb and/or barrier free entrance to be formed in said pans;
selecting a first grouping of cavity-side entrance inserts from the collection of cavity-side entrance inserts which collectively correspond in workpiece surface-forming characteristics to a desired shape of an upper surface of an entrance of a first shower pan;
selecting a first grouping of core-side entrance inserts from the collection of core-side entrance inserts which collectively correspond in workpiece surface-forming characteristics to a desired shape of a lower surface of an entrance of a first shower pan;
associating the first grouping of cavity-side entrance inserts with the one or more cavity-side mounting members;
associating the first grouping of core-side entrance inserts with the one or more core-side mounting member;
mating the one or more core-side and cavity-side members together and molding said first pan;
disassociating at least some of the first grouping of entrance inserts from the one or more cavity-side mounting members, and disassociating at least some of the first grouping of core-side entrance inserts from the one or more core-side mounting members;
selecting a second grouping of cavity-side entrance inserts from the collection of cavity-side entrance inserts which collectively correspond in workpiece surface-forming characteristics to at least a portion of a desired shape of an upper surface of an entrance feature of a second shower pan;
selecting a second grouping of core-side entrance inserts from the collection of core-side entrance inserts which collectively correspond in workpiece surface-forming characteristics to a desired shape of at least a portion of a lower surface of an entrance feature of a second shower pan;
associating the second grouping of cavity-side entrance inserts with the one or more cavity-side mounting members;
associating the second grouping of core-side entrance inserts with the one or more core-side mounting members;
mating the one or more core-side and cavity-side members together and molding a second pan;
wherein the first and second pans have at least one surface entrance feature that is different from the other.

9. The method of claim 6, further comprising:
providing a collection of cavity-side drain recess inserts, each being detachably securable to the one or more cavity-side mounting members at any one of a multiplicity of user-selected locations, each of said cavity-side drain recess inserts having at least a mounting side which faces said one or more cavity mounting members when connected thereto, and a workpiece-forming surface which defines at least a portion of a cavity-side of a drain recess to be formed in said pans;
providing a collection of core-side drain recess inserts, each being detachably securable to said one or more core-side mounting members at any one of a multiplicity of user-selected locations on said core-side mounting plate, each of said core-side drain recess inserts having at least a mounting side which faces said one or more core mounting members when connected thereto, and a workpiece-forming surface which defines at least a portion of a core side of said drain recess to be formed in said pans;
selecting a first grouping of cavity-side drain recess inserts from the collection of cavity-side drain recess inserts which collectively correspond in workpiece surface-forming characteristics to a desired shape of an upper surface of a drain recess of a first shower pan;
selecting a first grouping of core-side drain recess inserts from the collection of core-side drain recess inserts which collectively correspond in workpiece surface-forming characteristics to a desired shape of a lower surface of a drain recess of a first shower pan;
associating the first grouping of cavity-side drain recess inserts with the one or more cavity-side mounting members;
associating the first grouping of core-side drain recess inserts with the one or more core-side mounting members;
mating the one or more core-side and cavity-side mounting members together and molding said first pan;
disassociating at least some of the first grouping of drain recess inserts from the one or more cavity-side mounting members, and disassociating at least some of the first grouping of core-side drain recess inserts from the one or more core-side mounting members;
selecting a second grouping of cavity-side drain recess inserts from the collection of cavity-side drain recess inserts which collectively correspond in workpiece surface-forming characteristics to at least a portion of a desired shape of an upper surface of a drain recess feature of a second shower pan;
selecting a second grouping of core-side drain recess inserts from the collection of core-side drain recess inserts which collectively correspond in workpiece surface-forming characteristics to a desired shape of at least a portion of a lower surface of drain recess feature of a second shower pan;
associating the second grouping of cavity-side drain recess inserts with the one or more cavity-side mounting members;
associating the second grouping of core-side drain recess inserts with the one or more core-side mounting members;
mating the one or more core-side and cavity-side bases together and molding a second pan;
wherein the first and second pans have at least one surface drain recess feature that is different from the other.

10. The method of claim 6, further comprising:
providing a collection of cavity-side floor recess inserts, each being detachably securable to the one or more cavity-side mounting members at any one of a multiplicity of user-selected locations, each of said cavity-side floor recess inserts having at least a mounting side which faces said one or more cavity mounting members when connected thereto, and a workpiece-forming surface which defines at least a portion of a core side of said floor recess;
providing a collection of core-side floor recess inserts, each being detachably securable to the one or more core-side mounting members at any one of a multiplicity of user-selected locations, each of said core-side floor recess inserts having at least a mounting side which faces said one or more core mounting members when connected thereto, and a workpiece-forming surface which defines at least a portion of a core side of said floor recess;
selecting a first grouping of cavity-side floor recess inserts from the collection of cavity-side floor recess inserts which collectively correspond in workpiece surface-forming characteristics to a desired shape of an upper surface of a floor recess of a first shower pan;
selecting a first grouping of core-side floor recess inserts from the collection of core-side drain recess inserts which collectively correspond in workpiece surface-forming characteristics to a desired shape of a lower surface of a floor recess of a first shower pan; associating the first grouping of cavity-side floor recess inserts with the one or more cavity-side mounting members;
associating the first grouping of core-side floor recess inserts with the one or more core-side mounting members;
mating the one or more core-side and cavity-side mounting members together and molding said first pan;
disassociating at least some of the first grouping of floor recess inserts from the one or more cavity-side mounting members, and disassociating at least some of the first grouping of core-side floor recess inserts from the one or more coreside mounting members;
selecting a second grouping of cavity-side floor recess inserts from the collection of cavity-side floor recess inserts which collectively correspond in workpiece surface-forming characteristics to at least a portion of a desired shape of an upper surface of a floor recess feature of a second shower pan;
selecting a second grouping of core-side floor recess inserts from the collection of core-side floor recess inserts which collectively correspond in workpiece surface-forming characteristics to a desired shape of at least a portion of a lower surface of floor recess feature of a second shower pan;
associating the second grouping of cavity-side floor recess inserts with the one or more cavity-side mounting members;
associating the second grouping of core-side floor recess inserts with the one or more core-side mounting members;
mating the one or more core-side and cavity-side mounting members together and molding a second pan;
wherein the first and second pans have at least one floor recess feature that is different from the other.

11. The method of claim 6, further comprising:
providing a collection of cavity-side drain floor inserts, each being detachably securable to said one or more cavity-side mounting members at any one of a multiplicity of user-selected locations, each of said cavity-side drain floor inserts having at least a mounting side which faces said one or more cavity mounting members when connected thereto, and a workpiece-forming surface which defines at least a portion of a cavity side of said drain floor to be formed in said pans;
providing a collection of core-side drain floor inserts, each being detachably securable to said one or more core-side mounting members at any one of a multiplicity of user-selected locations, each of said core-side drain floor inserts having at least a mounting side which faces said one or more core mounting members when connected thereto, and a workpiece-forming surface which defines at least a portion of a core side of said drain floor to be formed in said pans;
selecting a first grouping of cavity-side drain floor inserts from the collection of cavity-side drain floor inserts which collectively correspond in workpiece surface-forming characteristics to a desired shape of an upper surface of a drain floor of a first shower pan;
selecting a first grouping of core-side drain floor inserts from the collection of core-side drain recess inserts which collectively correspond in workpiece surface-forming characteristics to a desired shape of a lower surface of a drain floor of a first shower pan; associating the first grouping of cavity-side drain floor inserts with the one or more cavity-side mounting members;
associating the first grouping of core-side inserts with the one or more core-side mounting members;
mating the one or more core-side and cavity-side mounting members together and molding said first pan;
disassociating at least some of the first grouping of drain floor inserts from the one or more cavity-side mounting members, and disassociating at least some of the first grouping of core-side drain floor inserts from the one or more core-side mounting members;
selecting a second grouping of cavity-side drain floor inserts from the collection of cavity-side drain floor inserts which collectively correspond in workpiece surface-forming characteristics to at least a portion of a desired shape of an upper surface of a drain floor feature of a second shower pan;
selecting a second grouping of core-side drain floor inserts from the collection of core-side drain floor inserts which collectively correspond in workpiece surface-forming characteristics to a desired shape of at least a portion of a lower surface of drain floor feature of a second shower pan;
associating the second grouping of cavity-side drain floor inserts with the one or more cavity-side mounting members;
associating the second grouping of core-side drain floor inserts with the one or more core-side mounting members;
mating the one or more core-side and cavity-side mounting members together and molding a second pan;
wherein the first and second pans have at least one drain floor feature that is different from the other.

12. The method of claim 6, further comprising:
providing a collection of cavity-side drain pitch transition inserts, each being detachably securable to said one or more cavity-side mounting members at any one of a multiplicity of user-selected locations, each of said cavity-side drain pitch transition inserts having at least a mounting side which faces said one or more cavity mounting members when connected thereto, and a workpiece-forming surface which defines at least a portion of a cavity-side of said drain pitch transition feature to be formed in said pans;
providing a collection of core-side drain pitch transition inserts, each being detachably securable to said one or more core-side mounting members at any one of a multiplicity of user-selected locations, each of said core-side drain pitch transition inserts having at least a mounting side which faces said one or more core mounting members when connected thereto, and a workpiece-forming surface which defines at least a portion of a core side of said drain pitch transition feature to be formed in said pans;
selecting a first grouping of cavity-side drain pitch transition inserts from the collection of cavity-side drain pitch transition inserts which collectively correspond in workpiece surface-forming characteristics to a desired shape of an upper surface of a drain pitch transition feature of a first shower pan;
selecting a first grouping of core-side drain pitch transition inserts from the collection of core-side shower floor recess inserts which collectively correspond in workpiece surface-forming characteristics to a desired shape of a lower surface of a drain pitch transition feature of a first shower pan;
associating the first grouping of cavity-side drain pitch transition inserts with the one or more cavity-side mounting members;
associating the first grouping of core-side drain pitch transition inserts with the one or more core-side mounting members;
mating the one or more core-side and cavity-side mounting members together and molding said first pan;
disassociating at least some of the first grouping of drain pitch transition inserts from the one or more cavity-side mounting members, and disassociating at least some of the first grouping of core-side drain pitch transition inserts from the one or more core-side mounting members;
selecting a second grouping of cavity-side drain pitch transition inserts from the collection of cavity-side drain pitch transition inserts which collectively correspond in workpiece surface-forming characteristics to at least a portion of a desired shape of an upper surface of a drain pitch transition feature of a second shower pan;
selecting a second grouping of core-side drain pitch transition inserts from the collection of core-side drain pitch transition inserts which collectively correspond in workpiece surface-forming characteristics to a desired shape of at least a portion of a lower surface of drain pitch transition feature of a second shower pan;
associating the second grouping of cavity-side drain pitch transition inserts with the one or more cavity-side mounting members;
associating the second grouping of core-side drain pitch transition inserts with the one or more core-side mounting members;
mating the one or more core-side and cavity-side mounting members together and molding a second pan;
wherein the first and second pans have at least one drain pitch transition feature that is different from the other.

13. The method of claim 6, wherein the shower pans are characterized as having one or more Neo-angle features, further comprising:
providing a collection of cavity-side Neo-angle inserts, each being detachably securable to the one or more cavity-side mounting members at any one of a multiplicity of user-selected locations, each of said cavity-side Neo-angle inserts having at least a mounting side which faces said one or more cavity mounting members when connected thereto, and a workpiece-forming surface which defines at least a portion of a cavity-side of said Neo-angle feature to be formed in said pans;
providing a collection of core-side Neo-angle inserts, each being detachably securable to said one or more core-side mounting members at any one of a multiplicity of user-selected locations, each of said core-side Neo-angle inserts having at least a mounting side which faces said one or more core mounting members when connected thereto, and a workpiece-forming surface which defines at least a portion of a core side of said Neo-angle feature to be formed in said pans;
selecting a first grouping of cavity-side Neo-angle inserts from the collection of cavity-side Neo-angle inserts which collectively correspond in workpiece surface-forming characteristics to a desired shape of an upper surface of a Neo-angle feature of a first shower pan;
selecting a first grouping of core-side Neo-angle inserts from the collection of core-side Neo-angle inserts which collectively correspond in workpiece surface-forming characteristics to a desired shape of a lower surface of a Neo-angle feature of a first shower pan;
associating the first grouping of cavity-side Neo-angle inserts with the one or more cavity-side mounting members;
associating the first grouping of core-side Neo-angle inserts with the one or more core-side mounting members;
mating the one or more core-side and cavity-side mounting members bases together and molding said first pan;
disassociating at least some of the first grouping of Neo-angle inserts from the one or more cavity-side mounting members, and disassociating at least some of the first grouping of core-side Neo-angle inserts from the one or more core-side mounting members;
selecting a second grouping of cavity-side Neo-angle inserts from the collection of cavity-side Neo-angle inserts which collectively correspond in workpiece surface-forming characteristics to at least a portion of a desired shape of an upper surface of a Neo-angle feature of a second shower pan;
selecting a second grouping of core-side Neo-angle inserts from the collection of core-side Neo-angle inserts which collectively correspond in workpiece surface-forming characteristics to a desired shape of at least a portion of a lower surface of Neo-angle feature of a second shower pan;
associating the second grouping of cavity-side Neo-angle inserts with the one or more cavity-side mounting members;
associating the second grouping of core-side Neo-angle inserts with the one or more core-side mounting members;
mating the one or more core-side and cavity-side mounting members together and molding a second pan;
wherein the first and second pans have at least one Neo-angle feature that is different from the other.

14. The method of claim 6, wherein the Neo curb or barrier free entrance is characterized by having neo-round features.

15. The method of claims 13 and 14, wherein two adjoining sides of the shower pans are characterized as being either a square Neo, where said two adjoining two shower pan sides having no curb or barrier entrance are equal in length, and a rectangular neo, where said two adjoining shower pan sides having no curb or barrier free entrance are unequal in length.

16. The method of claim 6, wherein the shower pans are characterized as having one or more angle cutoff features, further comprising:
providing a collection of cavity-side angle cutoff inserts, each being detachably securable to the one or more cavity-side mounting members at any one of a multiplicity of user-selected locations, each of said cavity-side angle cutoff inserts having at least a mounting side which faces said one or more cavity mounting members when connected thereto, and a workpiece-forming surface which defines at least a portion of a cavity-side of said angle cutoff feature;
providing a collection of core-side angle cutoff inserts, each being detachably securable to said one or more core-side mounting members at any one of a multiplicity of user-selected locations, each of said core-side angle cutoff inserts having at least a mounting side which faces said one or more core mounting members when connected thereto, and a workpiece-forming surface which defines at least a portion of a core side of said angle cutoff feature;
selecting a first grouping of cavity-side angle cutoff inserts from the collection of cavity-side angle cutoff inserts which collectively correspond in workpiece surface-forming characteristics to a desired shape of an upper surface of an angle cutoff feature of a first shower pan;
selecting a first grouping of core-side angle cutoff inserts from the collection of core-side angle cutoff inserts which collectively correspond in workpiece surface-forming characteristics to a desired shape of a lower surface of an angle cutoff feature of a first shower pan;
associating the first grouping of cavity-side angle cutoff inserts with the one or more cavity-side mounting members;
associating the first grouping of core-side angle cutoff inserts with the one or more core-side mounting members;
mating the one or more core-side and cavity-side mounting members together and molding said first pan;
disassociating at least some of the first grouping of angle cutoff inserts from the one or more cavity-side mounting members, and disassociating at least some of the first grouping of core-side angle cutoff inserts from the one or more core-side mounting members;
selecting a second grouping of cavity-side angle cutoff inserts from the collection of cavity-side angle cutoff inserts which collectively correspond in workpiece surface-forming characteristics to at least a portion of a desired shape of an upper surface of an angle cutoff feature of a second shower pan;
selecting a second grouping of core-side angle cutoff inserts from the collection of core-side angle cutoff inserts which collectively correspond in workpiece surface-forming characteristics to a desired shape of at least a portion of a lower surface of an angle cutoff feature of a second shower pan;
associating the second grouping of cavity-side angle cutoff inserts with the one or more cavity-side mounting members;
associating the second grouping of core-side angle cutoff inserts with the one or more core-side mounting members base;
mating the one or more core-side and cavity-side mounting members together and molding a second pan;
wherein the first and second pans have at least one surface feature that is different from the other.

17. A method for injection molding a variety of differently configured prefabricated shower pans using a single base tool, comprising:
providing one or more cavity-side mounting members from a group of mounting members consisting one or more cavity-side mounting plates and one or more cavity-side heating/cooling plates;
providing one or more mounting members from a group of mounting members consisting one or more core-side mounting plates and one or more core-side heating/cooling plates;
providing a collection of cavity-side inserts, each being detachably securable to the one or more cavity-side mounting members at any one of a multiplicity of user-selected locations, each of said cavity-side inserts having at least a mounting side which faces said one or more cavity mounting members when connected thereto, and a workpiece-forming surface which defines at least a portion of a top side of said pan;
providing a collection of core-side inserts, each being detachably securable to said one or more core-side mounting members at any one of a multiplicity of user-selected locations, each of said core-side inserts having at least a mounting side which faces said one or more core mounting members when connected thereto, and a workpiece-forming surface which defines at least a portion of a bottom side of said pan;
selecting a first grouping of cavity-side inserts from the collection of cavity-side inserts which collectively correspond in workpiece surface-forming characteristics to a desired shape of an upper surface of a first shower pan;
selecting a first grouping of core-side inserts from the collection of core-side inserts which collectively correspond in workpiece surface-forming characteristics to a desired shape of a lower surface of a first shower pan;
associating the first grouping of cavity-side inserts with the one or more cavity-side mounting members;
associating the first grouping of core-side inserts with the one or more core-side mounting members;
mating the one or more cavity-side mounting members and the one or more core-side mounting members together and molding said first pan;
disassociating the first grouping of cavity-side inserts from the one or more cavity-side mounting members, and disassociating the first grouping of core-side inserts from the one or more core-side mounting members;
selecting a second grouping of cavity-side inserts from the collection of cavity-side inserts which collectively correspond in workpiece surface-forming characteristics to a desired shape of an upper surface of a second shower pan;
selecting a second grouping of core-side inserts from the collection of core-side inserts which collectively correspond in workpiece surface-forming characteristics to a desired shape of a lower surface of a second shower pan;
associating the second grouping of cavity-side inserts with the one or more cavity-side mounting members;
associating the second grouping of core-side inserts with the one or more core-side mounting members;
mating the one or more cavity-side mounting members and the one or more core-side mounting members together and molding a second pan;
wherein the first and second pans have at least one surface feature that is different from the other.
